(19) United States
(12) Patent Application Publication
(10) Pub. No.: US 2025/0121283 A1
(43) Pub. Date: Apr. 17, 2025

(54) Interactive Game Room Control Systems and Methods

(71) Applicant: Alexander B. Patterson, Brooklyn, NY (US)

(72) Inventor: Alexander B. Patterson, Brooklyn, NY (US)

(21) Appl. No.: 18/913,892

(22) Filed: Oct. 11, 2024

Related U.S. Application Data
(60) Provisional application No. 63/590,373, filed on Oct. 13, 2023.
(60) Provisional application No. 63/590,375, filed on Oct. 13, 2023.

(51) Int. Cl. A63F 13/48; A63F 13/46

(52) U.S. Cl. CPC A63F 13/48; A63F 13/46

(57) ABSTRACT

The interactive game room systems described herein incorporates various components such as player data, game data, control data, and a network of servers to support interactive game room facility management. Player data may include names, team affiliations, historical gameplay, and preferences, while game data is generated from sensors within the room, tracking player actions and game states. Control data can regulate technician access to various features, depending on authorization levels and game types. These systems can be interconnected via servers, enabling seamless communication between game logic, status screens, control apps, and site operations. Machine learning can be used to analyze player data and control interactions, optimizing game configurations and technician controls. Additionally, machine learning can improve team onboarding such as assignments, waiver processing, and gameplay by leveraging historical data to offer personalized experiences. Together, this can create a robust, flexible environment for managing interactive games, allowing for efficient gameplay.

### PRIORITY

This application claims the benefit of and priority to U.S. Provisional application, entitled “Interactive Gaming onboarding Systems and Methods”, filed on Oct. 13, 2023 and having application Ser. No. 63/590,373, and U.S. Provisional application entitled “Interactive Game Control Room Systems and Methods”, filed on Oct. 13, 2023 and having application Ser. No. 63/590,375, the entirety of said application being incorporated herein by reference.

### FIELD

The present disclosure relates to interactive gaming. More particularly, the present disclosure relates to methods and systems for controlling interactive gaming sessions between one or more interactive game rooms and facilities.

### BACKGROUND

Traditional methods for interactive game control systems have struggled with various limitations in terms of connectivity, functionality, and real-time interaction. Early systems typically relied on separate components, each handling a specific task without integrating into a cohesive, unified system. For instance, standalone processors were often used to manage game control logic and generate basic interfaces, but these systems lacked the ability to connect seamlessly with other devices within the interactive game room. This disjointed setup made it difficult for game systems to monitor game states in real time, limiting their ability to adjust dynamically based on player actions or environmental factors. Additionally, these early systems were not capable of receiving game control input directly from players, which hampered the overall interactive experience.

Furthermore, some systems try to incorporate network internet controllers to enable connectivity between the control system and external devices. While this allows for some level of communication between the game system and room components, these systems were often unable to offer a unified solution for managing game control. The absence of dedicated memory to store game logic further exacerbated these issues, limiting the system's ability to handle complex tasks or retain necessary data for ongoing game sessions. As a result, these systems were often inflexible, requiring frequent manual intervention and lacking the ability to generate real-time notifications or manage a broad range of interactive devices effectively.

In terms of player onboarding, traditional systems were also fraught with inefficiencies. Manual processes dominated early methods, requiring operators to manually input player data, assign games, and display information on screens. This approach was not only time-consuming but also prone to errors and inconsistencies, making the overall experience less streamlined and more labor-intensive. Additionally, these manual processes offered little to no customization for individual players, as games were often assigned based on predetermined criteria or random selection, without considering personal preferences or skill levels. Even with some attempts at automating the onboarding process, the systems were often rigid, unable to dynamically adjust to real-time information or customize the experience for each player. This lack of flexibility resulted in a less engaging and personalized onboarding experience, hindering the interactive nature of the games themselves.

### SUMMARY OF THE DISCLOSURE

Systems and methods for methods and systems for controlling interactive gaming sessions in accordance with embodiments of the disclosure are described herein.

In some embodiments, an interactive game control system includes a processor; a network internet controller; a memory, wherein the memory includes an game control logic, wherein the game control logic directs the system to: receive a plurality of player data; generate a notification to players associated with a game start; connect to at least one component within an interactive game room; generate a game control interface; monitor game states associated with the interactive game room; and receive game control input.

In some embodiments, the player data is received from a game onboarding process.

In some embodiments, the notification can be generated as a display on a plurality of devices.

In some embodiments, the plurality of devices includes a display in a preview room of the interactive game facility.

In some embodiments, the plurality of displays includes a display at the entrance way of an interactive game room.

In some embodiments, the notification can be generated as a push notification to a user.

In some embodiments, the push notification is directed at a mobile computing device associated with the player.

In some embodiments, access to the mobile computing device is gained from the game onboarding process.

In some embodiments, the push notification is directed at a social media account associated with the player.

In some embodiments, the access to the social media account was gained during a game onboarding process.

In some embodiments, the game control interface is generated via a graphical user interface.

In some embodiments, the control interface is displayed on a display associated with a game technician.

In some embodiments, monitored game states includes one of: team size, total score, room score, session identification number, team name, and players associated with the team.

In some embodiments, connecting to at least one game component can be done via a network connection.

In some embodiments, the at least one game component can be controlled by the game control logic.

In some embodiments, control of the at least one game component can allow for suspension of the game.

In some embodiments, control of the at least one game component can allow for termination of the game.

In some embodiments, control of the at least one game component can allow for starting a game.

In some embodiments, control of the at least one game component can allow for the selection of an interactive game from a list of compatible interactive games.

In some embodiments, the game technician can manually adjust the allocation of players amongst the teams available for gameplay.

In some embodiments, an interactive game onboarding system includes a processor; a network internet controller; a memory, wherein the memory includes an onboarding logic, wherein the onboarding logic directs the system to: receive a plurality of player data; modify the player data by assigning at least one player to a series of interactive games; format the player data for display; display the player data on a plurality of displays.

In some embodiments, the player data is received from a player inputting data during a check-in process.

In some embodiments, the player input is received from a check-in device.

In some embodiments, the check-in device is a tablet computing device.

In some embodiments, the player input is received from a web server.

In some embodiments, the web server received the player input from a web-based intake form.

In some embodiments, at least two or more players input player data.

In some embodiments, the player data is further modified by assigning each of the two or more players to one or more teams.

In some embodiments, the assigning of teams is done by the players.

In some embodiments, the assigning of teams is done randomly.

In some embodiments, the assigning of teams is done by a game administrator.

In some embodiments, formatting the player data includes at least generating team names. In some embodiments, the team names are assigned randomly.

In some embodiments, the team names are selected by the players in the team.

In some embodiments, formatting the player data further includes displaying player names.

In some embodiments, formatting the player data further includes displaying player scores.

In some embodiments, the plurality of displays includes at least a display associated with a game technician.

In some embodiments, the plurality of displays includes at least one or more displays situated outside of an interactive game room area.

In some embodiments, formatting the player data further includes generating an indication of which game room each player should proceed to.

In some embodiments, formatting the player data further includes generating an indication of when the game will start for the player.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a screenshot of a check-in graphical user interface for an interactive game onboarding logic in accordance with various embodiments of the disclosure;

FIG. 2 is a screenshot of a team loading graphical user interface for an interactive game onboarding logic in accordance with various embodiments of the disclosure;

FIG. 3 is a screenshot of a mission selection graphical user interface for an interactive game onboarding logic in accordance with various embodiments of the disclosure;

FIG. 4 is a screenshot of an interactive game setup graphical user interface for an interactive game onboarding logic in accordance with various embodiments of the disclosure;

FIG. 5 is a screenshot of a check-in control graphical user interface for an interactive game control logic in accordance with various embodiments of the disclosure;

FIG. 6 is a screenshot of a control room graphical user interface for an interactive game control logic in accordance with various embodiments of the disclosure;

FIG. 7 is a screenshot of a team assignment graphical user interface for an interactive game control logic in accordance with various embodiments of the disclosure;

FIG. 8 is a screenshot of a team authorization graphical user interface for an interactive game control logic in accordance with various embodiments of the disclosure;

FIG. 9 is a screenshot of a team setup graphical user interface for an interactive game control logic in accordance with various embodiments of the disclosure;

FIG. 10 is a screenshot of a mission selection graphical user interface for an interactive game control logic in accordance with various embodiments of the disclosure;

FIG. 11 is a conceptual illustration of a location server and client architecture for a control game logic in accordance with various embodiments of the disclosure;

FIG. 12 is a conceptual block diagram of a device suitable for operating a control game logic in accordance with various embodiments of the disclosure;

FIG. 13 is a diagram depicting various subsets of artificial intelligence in accordance with various embodiments of the disclosure;

FIG. 14 depicts different methods of machine-based learning in accordance with various embodiments of the disclosure;

FIG. 15 depicts a machine learning lifecycle in accordance with various embodiments of the disclosure; and

FIG. 16 is an exemplary neural network for use in an interactive game control system in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that allow for controlling of one or more interactive games through various methods and systems.

In many embodiments, interactive game operators can operate a standardized and networked set of game rooms, which may all be configured to operate on the same logic/program connected to one or more centralized server(s). These interactive game room experiences that are created can include players undertaking a sequential series of game rooms, with each room being a different gaming experience from a predetermined game set, chosen by the players or the employees of the facility. Versions of this system can allow the players to choose their own games in each room, allow them to play multiple games in each room, allow the players or facility employees to alter the time limit for the games in each room, and allow the players to play games in an order that is not a linear order of the rooms as they architecturally are arranged in the space (i.e., play a sequential set of game rooms that is not in the order that they are arranged in the space). In various embodiments, interactive game room control systems can allow a wide variety of gaming experience structures, including linear game room sequences, as well as networked room versus room challenges where two or more teams are competing in the same game between two or more game rooms. Those games may be distinct representations of the same games, or they may actually be different rooms all joined into the same virtual game space, (i.e., playing in the same game).

In more embodiments, gaming experience structures may see many teams competing at different times in the same games, with the scores placed on a leaderboard, as well as game structures in which many teams are playing the same games and certain teams are knocked out of the competition if their performance is not good enough. Gaming experiences may also be available in which a large group made up of many teams of multiple players is competing against another large group to score total points, or in which a large group of many teams have the team rosters switched up either every game or periodically in order to foster players having a greater number of social interactions throughout the course of the overall gaming experience.

Certain embodiments of the interactive game room control system can be characterized by software-based controls that can start games, stop games, add or remove time from games, and/or add or subtract scores from games. In some embodiments, there may be a plurality of displays or other interactive game room devices/components within an interactive game room configured to start the game. In further embodiments, at least one of the plurality of displays/devices can be deployed at an entrance way of an interactive game room, which can further function to notify upcoming players of different game states such as room availability, which players are currently playing, which players will play next, estimated wait time, etc.

Visual status screens can further show a digital representation of the rooms within the facility, giving an facility employee a view of the status of all of the game rooms, including what game experiences are playing in them, how long those game experience are scheduled to last, which teams (and which players) are in those rooms playing the gaming experiences, and statistics such as how well the teams are doing at any time in the game rooms. In some embodiments, statistics as to how many points the team has gotten or what their record is in their overall gaming experience are generated.

Given that interactive game operators facilitate a plurality of unique digital games that utilize unique gaming devices, computing devices, and other hardware that can have faults and break. In response, a visual warning system can be deployed whereby not only are the room states of occupation and/or operation, but if a team has not scored any points in a game within a certain time limit such as two minutes, the visual game control interface can be generated via or as a graphical user interface and show a color code on that room's indicated area of the status screen. This can be configured to alert the facility employees that the team is having difficulty scoring in the game, which might be a function of their skill level, or alternatively might be an indication that one or more of the devices in the room is malfunctioning and/or broken. Various embodiments of the interactive game room control system can also be upgraded to where the technology in the room is constantly sending signals to a central server as to that device's status, whether it is online and/or working properly, or offline. This can be configured to provide an automated view and reporting system across a wide range of potential technical issues that could arise within the games.

In more embodiments, the interactive game room control system can be configured with integrations with a photo and/or video system. This can allow additional features such as being able to view content stored within a database, and then download, print, or send photo and/or video files through the system to customers. In some embodiments, the interactive game room control system can be deployed such that the operation of a multi-function ejection device (i.e., the device that ejects paint/foam/slime/polyurethane balls/etc.) can not only be controlled by its own control hardware, but through software commands within the interactive game room control system.

In still more embodiments, the interactive game room control system can be used to change the gaming content that the players will be experiencing, including choosing different versions of games that are either easier or harder. For example, some embodiments may deploy a specifically created interactive game for different school-age grade levels (such as 3rd grade, 4th grade, 5th grade, etc.) in response to receiving groups of children for field trips. The interactive game room control system can monitor all games in real-time (or near real-time) and retain and display a wide range of statistics on all aspects of the interactive game room control system, including how many games have been played in a particular time frame, the timing between the games, the imputed efficiency of the system, the number of players who have played, the total minutes played, the scores of all games in the game rooms, etc.

In further embodiments, the interactive game room control system can have one or more centralized instances to be able to control and view the performance of the system of not just one location of interactive game operators/facilities, but of multiple locations remotely. In some embodiments, the interactive game room control system also can be integrated with a permissions and payments layer whereby the interactive game operators and its component game rooms can be locked or rendered non-functional based on an integrated payments layer. For example, it can be configured such that only when a game room or game room session is given permission to be active and on from the interactive game room control systems. Upon approval, these rooms can be available for play, and within that the interactive game room control systems can impose time-based requirements, game-credit based requirements, or other requirements of control before game rooms, and/or particular game experiences can be played.

In these embodiments, if interactive game operators would like to require all players in a game room to have paid for a certain experience, the interactive game room control systems can be integrated with a payments platform to require that before a game experience will be delivered. That same goes from any centralized individual game control room system, whereby a central control mechanism can be put in place such that entire Interactive game operators locations and/or their constituent parts can be turned on or alternatively turned off or rendered non-functional if certain permissions have not been afforded them. As an example, if interactive game operators had a licensed affiliate unit in San Francisco, and that affiliate unit had not paid a licensing fee, interactive game operators could use control functions within a centralized interactive game room control systems to “turn off” the San Francisco Unit's Game System.

The computer code running the servers associated with the interactive game room control systems can manage the multitude of interactions between hardware devices and software code. Moreover, the interactive game room control systems can be configured with features to allow the uploading of new content to the system's content library of gaming experiences. User interfaces for all of the foregoing features and functionality are contemplated as being included in various embodiments of the herein described interactive game room control systems.

In additional embodiments, systems can be configured for participants to pay for a ticket in a digital system. These systems can be deployed for people to sign a legal liability waiver prior to participation in an entertainment or sporting activity such as one or more games that occur within interactive game rooms. In certain embodiments, potential players can be required to input their personal information, thus allowing the activity provider to know the information of presumably who has been provided general access to an entertainment or sporting facility. Simple colored wristbands, and even more advanced RFID wearable devices can be used to afford access to a theme park or entertainment location.

For example, with a simple colored wearable being configured to be identified by sight by employees of the theme park or entertainment location, and perhaps more advanced RFID wristband systems can allow a person to carry personally identifying information (PII) or other personal information such as, but not limited to, credit card payment information so as to use the wristband to buy merchandise. Those skilled in the art will recognize that a system could be developed that would not only require players to sign a legal liability waiver, but which could associate those people with a paid-for reservation for one of a number of potentially different experiences, each of which could be a different defined set of games to be played in a linear order, and which could then by either an employee's determination or the players' own preferences join groups of players into sub-teams, thereafter programming those teams with one of a multitude of digital gaming experiences (again ether by an employee's designation or by the players' own preferences). In these embodiments, when those participants go to access a particular gaming room, a room-based gaming system or interactive game room control system could identify who those participants were, and what gaming content they had been assigned, and then it would play that gaming content.

In still more embodiments, an onboarding system can allow employees of the facility to see reservations in the system, view customer and player waiver information, create teams, modify teams, delete teams, program content for the teams, see game scores, change game scores, print game scores, view photo and video content captured and associated with the teams, among other features. With more than one team available to be playing in the facility, the interactive game room control system, and associated onboarding system can also create a list or queue of teams that are in line to enter the experience, which queue can be edited by the employees of the facility. These embodiments are described below in more detail.

In various embodiments, one of the features can include the ability for players to navigate through a series of game rooms, with flexibility in the order of play and the ability to alter game time limits or select multiple games within a room. In certain embodiments, the game room can have various interactive game components (i.e., interactive game devices) that can be configured to suspend or terminate the game being played, as well as starting it when appropriate. For example, a list of interactive games may be presented to a user for selection from a list of compatible interactive games. The compatibility can be based on the available and functional game room devices, etc. The system can enable a wide variety of gaming structures, including linear sequences or networked room challenges, where players from different rooms compete in the same game. These games can either represent the same virtual space or different experiences linked together, offering players diverse ways to engage with the gaming environment.

In still further embodiments, the interactive game control system within the interactive game studio facility can be configured with a preview room outside the plurality of game rooms that may allow one or more upcoming players to see the action occurring within a game room. In some embodiments, the preview room can be equipped with a plurality of touchscreen devices which may, for instance, generate or otherwise display an indication that an interactive game room is ready for use or communicate some other game state or change in game state. In certain embodiments, a notification generated by the interactive control game system to notify upcoming players on the availability of an interactive game room can be done as a push notification on the players mobile computing devices such as, but not limited to, their mobile phone or smart watch. Other uses for this push notification can be achieved by sharing photos, videos, and other data with the players through communication to their mobile devices. In some embodiments, the push notification can be to a player's social media accounts/feeds. Access to these social media or other online player accounts can be provided during an onboarding/check-in process in certain embodiments. In various embodiments, the interactive game facility can provide upcoming players with a mobile computing device (e.g., a tablet, etc.) that can be accessed via communication to a game onboarding process or system within the interactive game control system.

In yet more embodiments, the control system can also support multiple team configurations and competitive structures, allowing for flexible game formats. Teams may compete at different times with scores displayed on leaderboards, and certain teams may be eliminated based on their performance. The system may be capable of organizing large group competitions, where teams can be rearranged between games to encourage social interaction and enhance the overall experience. In some embodiments, a game technician or operator can manually adjust the allocation of players amongst the teams. This can be done for fairness, limitations, handicap, etc. Additionally, this structure can enable complex scenarios where many teams play against one another or as part of larger groups in pursuit of total points or other objectives, providing a customizable and immersive gaming experience.

Finally, some embodiments of the control system can offer robust management features, allowing operators to control various aspects of the games, such as starting or stopping games, adjusting scores, and managing time limits. A visual interface allows employees to monitor the status of each game room, providing real-time updates on game durations, teams, and performance statistics. The system can also be equipped with diagnostic tools, offering alerts when devices malfunction or when players experience difficulties during gameplay. In more advanced configurations, the system can manage media content, such as photo and video captures of gameplay, and control special game features like multi-function ejection devices. Overall, this system provides a comprehensive solution for managing both the technical and interactive aspects of a game room facility.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

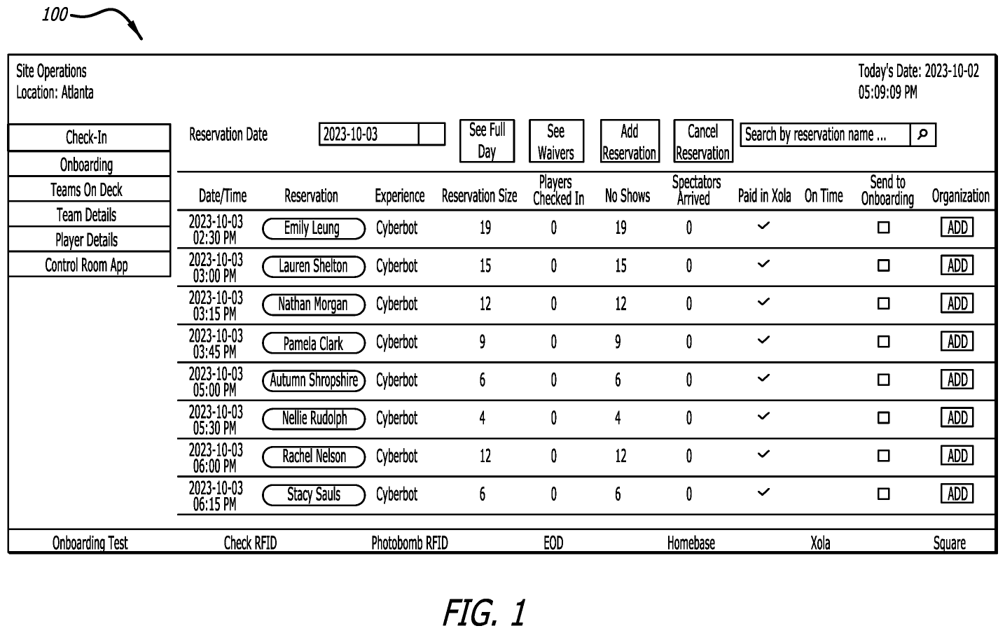

Referring to FIG. 1, a screenshot of a check-in graphical user interface 100 for an interactive game onboarding logic in accordance with various embodiments of the disclosure is shown. In many embodiments, a check-in graphical user interface 100 can be utilized to gather data related to players who are checking in to play an interactive game. This data can be obtained manually from a game technician, or may be imported from an intake device, such as a tablet. In more embodiments, the player data for the check-in graphical user interface 100 can be sent from a mobile application.

In the embodiment depicted in FIG. 1, a detailed view of a check-in graphical user interface (GUI) 100, is designed to streamline the onboarding and management of players within an interactive game facility. The interface organizes key data such as reservation information, player check-in status, and other operational details, allowing facility employees to efficiently manage multiple groups throughout the day. For example, the reservation list in FIG. 1 shows various players scheduled for a game experience called “Cyberbot,” with details including the reservation time, group size, and the number of players checked in. This allows staff to quickly see which groups are ready to start and which still need to complete the check-in process. The interface also tracks no-shows and spectators, ensuring that every participant's status is accounted for.

Additionally, in some embodiments, the check-in GUI 100 can include several action buttons and tools for managing reservations. At the top, the system can allow employees to “See Full Day,” “See Waivers,” “Add Reservation,” or “Cancel Reservation,” providing flexible control over daily operations. These functions can be utilized in a fast-paced environment where reservations may change throughout the day, as seen in the example where groups of various sizes are scheduled at 15-minute intervals, from 2:30 PM to 6:15 PM. For instance, the group led by Emily Leung has a reservation for 19 players, all of whom are checked in, whereas the group led by Lauren Shelton has 15 players, but none have been checked in yet. This level of detail allows staff to quickly identify groups that require further action, such as those needing waivers signed or additional onboarding steps.

The figure also illustrates how the system integrates with other aspects of game management, such as onboarding and team assignment. For instance, once a group has been checked in, the system provides an option to “Send to Onboarding,” which can initiate the next steps of the player's journey, whether that involves assigning teams, providing game instructions, or managing waivers. The use of a centralized system helps reduce the potential for errors that come with manual processes, ensuring that every group is properly onboarded and ready to participate in the game. Moreover, the GUI displays the organization each group is associated with, helping employees manage bookings from different sources, such as corporate groups or special events.

Finally, in some embodiments, the lower section of the check-in GUI 100 can include additional tools such as, but not limited to, “Onboarding Test,” “Check RFID,” and “Photobomb RFID,” providing quick access to specialized functions related to onboarding or player identification. These features are especially useful for ensuring that players are properly identified and associated with their respective game experiences, further improving the accuracy of player tracking and game management. The comprehensive nature of this check-in GUI 100 can allow interactive game facility operators to maintain control over the entire process from the moment players check in, to the time they are onboarded and begin their game. The customizable elements, such as the ability to adjust reservation details and manage player status in real-time, make this interface an invaluable tool for the smooth operation of large-scale interactive game facilities.

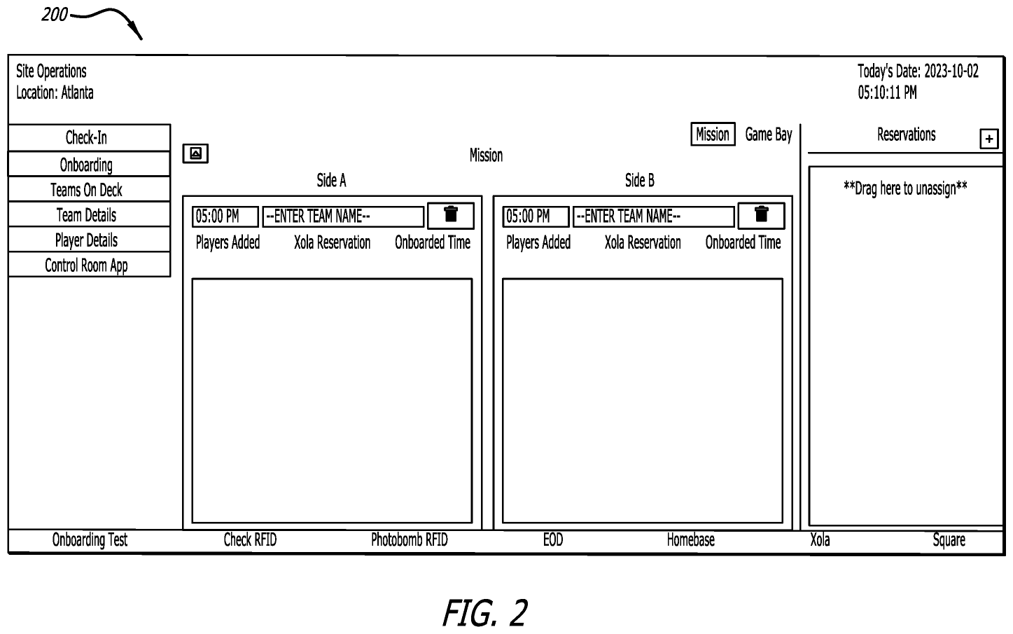

Although a specific embodiment for a check-in graphical user interface for an interactive game onboarding logic suitable for carrying out the various steps, processes, methods, and operations described herein is discussed with respect to FIG. 1, any of a variety of systems and/or processes may be utilized in accordance with embodiments of the disclosure. For example, the specific layout and functionality of the graphical user interface may be adjusted or otherwise changed based on the application desired. The elements depicted in FIG. 1 may also be interchangeable with other elements of FIGS. 2-16 as required to realize a particularly desired embodiment.

Referring to FIG. 2, a screenshot of a team loading graphical user interface 200 for an interactive game onboarding logic in accordance with various embodiments of the disclosure is shown. In many embodiments, a team loading graphical user interface 200 can be utilized to select or otherwise load teams together via a graphical user interface to play an interactive game. This selection can be obtained manually from a game technician, or may be generated from a machine-learning process that takes historical data into context. In more embodiments, the historical data may be imported from an external site.

In various embodiments, the team loading graphical user interface (GUI) 200, as depicted in FIG. 2, can be a comprehensive tool designed to simplify the process of creating and managing teams within an interactive game environment. The interface can be configured to allow game operators to manually or automatically load players into teams for gameplay, either by manually entering information or leveraging historical data from previous games. In some embodiments, the layout can be configured as a user-friendly interface featuring two main sections labeled “Side A” and “Side B,” which are likely used for team-based games where two opposing teams compete. Game technicians can enter team names and assign groups of players to each side, helping ensure balanced teams and seamless game organization.

The figure of FIG. 2 shows that each side (A and B) has fields to input key team information, such as the time at which the teams were added (e.g., “05:00 PM”) and a field to enter the team name (e.g., “—ENTER TEAM NAME—”). There is also an area titled “Xola Reservation,” which can track whether the team has confirmed its participation through a reservation system. Next to this, the “Onboarded Time” field allows administrators to track when the teams were fully loaded into the system, ensuring they are ready to start at the scheduled time. Additionally, there is a small delete icon (represented by a trash can) next to each team's entry, giving administrators the option to remove teams or make changes as needed. This flexibility in team management can be beneficial, especially in fast-paced environments where players may need to be reassigned or adjusted before gameplay begins.

In certain embodiments, the right side of the teal loading GUI 200 features a “Reservations” section where additional teams or reservations can be viewed and managed. This section includes a note to “Drag here to unassign,” providing an intuitive drag-and-drop feature for game administrators to easily remove or reassign teams. This functionality ensures that the system remains dynamic, allowing for real-time changes and updates to team configurations. For example, if a team needs to be removed from the game or reassigned to a different session, game operators can quickly unassign them by dragging their reservation to this section. This feature simplifies team management, helping ensure that teams are properly organized and ready to play without unnecessary delays.

At the bottom of the interface depicted in FIG. 2, additional tools such as “Onboarding Test” and “Check RFID” are available, adding further functionality to the team-loading process. These tools can help administrators confirm that all players are properly onboarded and equipped with the necessary RFID devices, ensuring that every team member is accounted for before the game begins. The “Photobomb RFID” tool may be related to verifying or troubleshooting player information related to RFID wristbands for matching with photobooths within bomb rooms, which are often used to track player actions during gameplay and game finales. Overall, this team loading graphical user interface 200 provides a powerful yet simple way to organize teams, verify player readiness, and manage reservations in an interactive game setting, ensuring a smooth transition from onboarding to active gameplay.

Although a specific embodiment for a screenshot of a team loading graphical user interface for an interactive game onboarding logic suitable for carrying out the various steps, processes, methods, and operations described herein is discussed with respect to FIG. 2, any of a variety of systems and/or processes may be utilized in accordance with embodiments of the disclosure. For example, the specific layout and functionality of the graphical user interface may be adjusted or otherwise changed based on the application desired. The elements depicted in FIG. 2 may also be interchangeable with other elements of FIGS. 1 and 3-16 as required to realize a particularly desired embodiment.

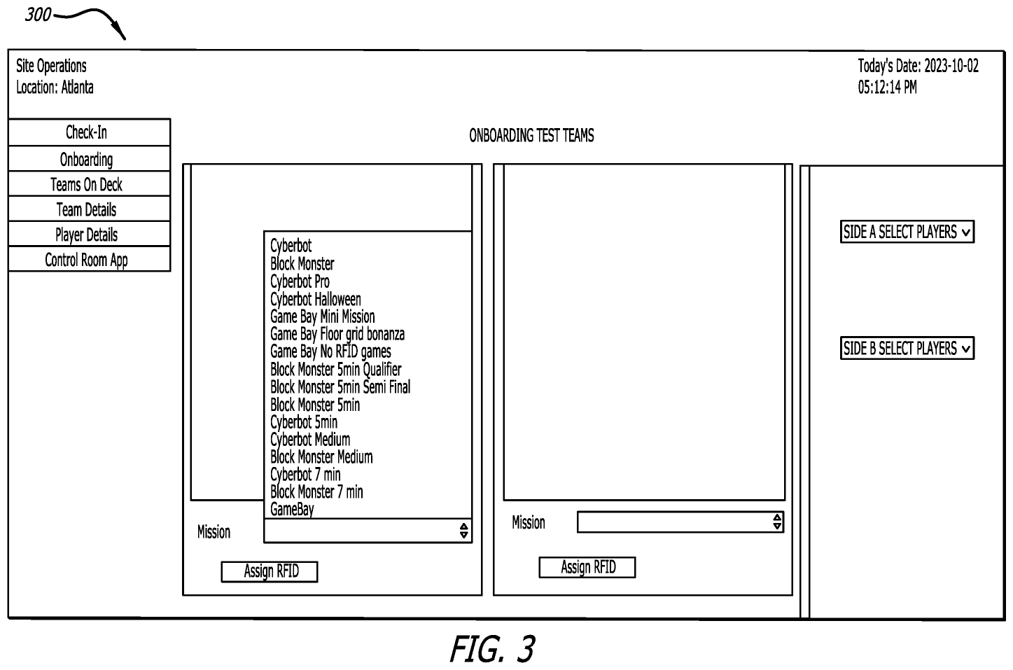

Referring to FIG. 3, a screenshot of a mission selection graphical user interface 300 for an interactive game onboarding logic in accordance with various embodiments of the disclosure is shown. In many embodiments, a mission selection graphical user interface 300 can be utilized to select or otherwise load an interactive game or series of games for a team via a graphical user interface for playing in an interactive game room. This selection can be obtained manually from a game technician, or may be generated from a machine-learning process that takes historical data into context. In more embodiments, the historical data may be imported from an external site.

The mission selection graphical user interface (GUI) 300, as depicted in FIG. 3, is configured as a tool for game operators to manage and organize interactive game experiences. The interface can be designed to streamline the process of selecting missions or games for teams that are about to enter the game room. On the left side of the depicted interface, the system displays a list of available missions/games such as “Cyberbot,” “Block Monster,” “Cyberbot Pro,” and several versions of the same games such as “Cyberbot 5 min,” “Cyberbot Medium,” and “Block Monster 5 min Qualifier.” This variety can help ensure that operators can assign the most appropriate game experience based on the team's preferences, skill level, or the specific scenario that needs to be executed. The selection process is configured to be easier to navigate, with a scrollable list, allowing administrators to quickly choose from different missions and configure gameplay on the fly.

In more embodiments, the neighboring section of the mission selection GUI 300 can include a field for assigning RFID devices to players, which may allow the system to track and monitor each player's progress and involvement throughout the game. The “Assign RFID” button is a feature for ensuring that every player is correctly onboarded and linked to the game, enabling seamless player management. By assigning RFID tags to individual players, the system can track their specific actions during the game, ensuring a fully immersive and interactive experience. This can also allow for the game system to generate accurate game data, including statistics and scores, based on each player's performance, which can be displayed in real-time or reviewed after the game.

In a number of embodiments, the right-hand side of the mission selection GUI 300 can feature two distinct sections, labeled “Side A” and “Side B,” which can be used for organizing teams or groups of players in competitive scenarios. For example, in a head-to-head game like “Block Monster,” players would be split into two teams, and the operator can use the drop-down menus on both sides to assign players to each respective team. These sections also provide spaces to input the mission type and team names, ensuring that both teams are clearly identified within the system. The mission selection GUI 300 can allow for flexibility in assigning players, and the operator can easily adjust the teams or mission as needed. This structure helps ensure that both teams are well-organized before entering the game, allowing for a smooth and coordinated gameplay experience.

In addition to its manual functionalities, various embodiments of the mission selection GUI 300 can also integrate machine-learning processes, as described in the passage, which can suggest missions or games based on historical player data. For instance, if players have previously completed beginner-level games like “Cyberbot 5 min,” the system may recommend more advanced missions, such as “Cyberbot Pro” or “Block Monster Semi Final.” This feature can ensure that each game experience is tailored to the players' skill levels and preferences, making the games more engaging and personalized. Moreover, historical data from external sources can be imported into the system, providing additional context for mission selection.

Although a specific embodiment for a screenshot of a mission selection graphical user interface for an interactive game onboarding logic suitable for carrying out the various steps, processes, methods, and operations described herein is discussed with respect to FIG. 3, any of a variety of systems and/or processes may be utilized in accordance with embodiments of the disclosure. For example, the specific layout and functionality of the graphical user interface may be adjusted or otherwise changed based on the application desired. The elements depicted in FIG. 3 may also be interchangeable with other elements of FIGS. 1-2 and 4-16 as required to realize a particularly desired embodiment.

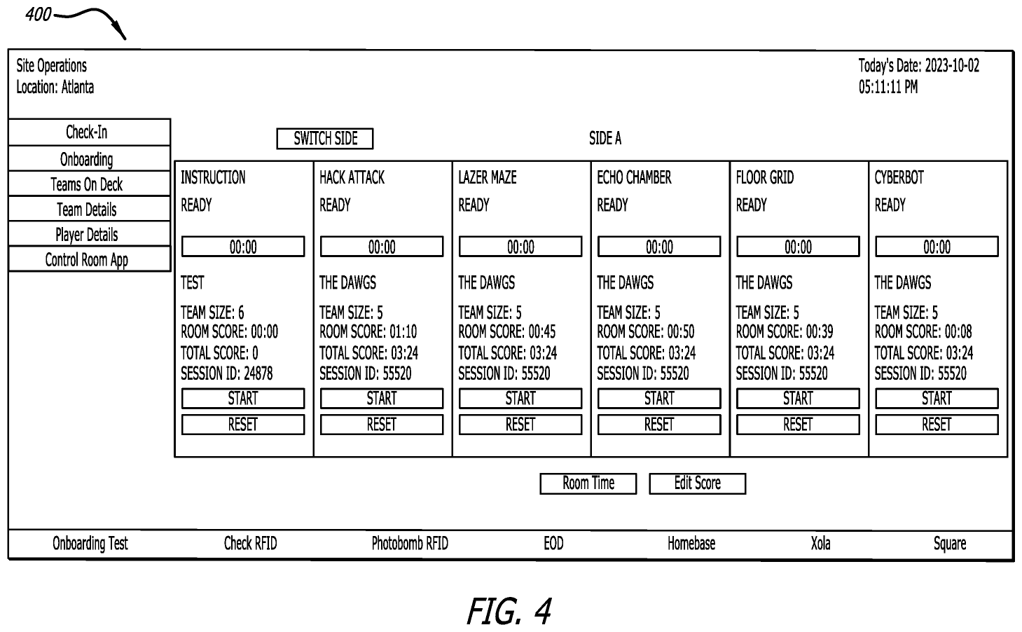

Referring to FIG. 4, a screenshot of an interactive game setup graphical user interface 400 for an interactive game onboarding logic in accordance with various embodiments of the disclosure is shown. In many embodiments, an interactive game setup graphical user interface 400 can be utilized to setup or otherwise prepare an interactive game room for an interactive game or series of games for a team via a graphical user interface. This selection can be obtained manually from a game technician, or may be generated from a machine-learning process that takes historical data into context. In more embodiments, the historical data may be imported from an external site.

The interactive game setup graphical user interface (GUI) 400, as depicted in FIG. 4, can serve as a comprehensive tool for game operators to manage and prepare game rooms for teams participating in various interactive games. In various embodiments, the game setup GUI 400 can be designed to monitor the setup status of multiple game rooms at once, ensuring that each room is ready for gameplay. The depicted game setup GUI 400 lists several game rooms, such as “Instruction,” “Hack Attack,” “Lazer Maze,” “Echo Chamber,” “Floor Grid,” and “Cyberbot”, etc., each marked as “Ready,” indicating that they have been successfully prepared for the upcoming game. This visual layout can provide operators with an at-a-glance view of the room statuses, allowing them to manage multiple teams and game experiences simultaneously, reducing the potential for delays or issues during the gameplay process.

Each room listed in the depicted game setup GUI 400 displays details that help the operator keep track of the team's progress and overall game performance. For example, the room “Hack Attack” has a team named “The Dawgs” with a team size of five players. The interface also tracks the “Room Score,” which in this case is 01:10, and the “Total Score” across all games, which is 03:24. This level of detailed tracking provides the operator with insights into each team's performance within a specific game room, as well as their overall progress through the series of games. Additionally, the “Session ID” listed for each room (e.g., 55520 for Hack Attack) can help maintain accurate records of the game sessions, allowing for efficient tracking, post-game analysis, and troubleshooting if necessary.

In more embodiments, a feature of this game setup GUI 400 is the ability to manually control the start and reset functions for each game room. The “Start” and “Reset” buttons located below each room's information can provide operators with the flexibility to begin or restart games as required. For example, if a team requests a restart due to technical difficulties or wants to replay a mission, the operator can easily hit the “Reset” button, which can clear the current progress and prepares the room for a fresh start. This flexibility can ensure that the interactive gaming experience remains smooth and responsive to the needs of the players, while also giving the operator full control over the pace and timing of the games.

The bottom section of the game setup GUI 400 can include, in some embodiments, additional controls, such as the “Room Time” and “Edit Score” functions, which allow operators to modify the game's timing or adjust scores if necessary. This could be particularly useful in competitive scenarios, where game timing needs to be precisely managed, or where scores need to be edited due to special circumstances or game modifications. The GUI can also provide the option to switch between sides (“Switch Side”) if needed, potentially accommodating different team configurations or game setups. With these versatile features, the interactive game setup GUI 400 offers a robust platform for managing game room configurations, providing both flexibility and real-time control, ensuring that game sessions are well-coordinated and offer a seamless experience for all participants.

Although a specific embodiment for a screenshot of an interactive game setup graphical user interface for an interactive game onboarding logic suitable for carrying out the various steps, processes, methods, and operations described herein is discussed with respect to FIG. 4, any of a variety of systems and/or processes may be utilized in accordance with embodiments of the disclosure. For example, the specific layout and functionality of the graphical user interface may be adjusted or otherwise changed based on the application desired. The elements depicted in FIG. 4 may also be interchangeable with other elements of FIGS. 1-3 and 5-16 as required to realize a particularly desired embodiment.

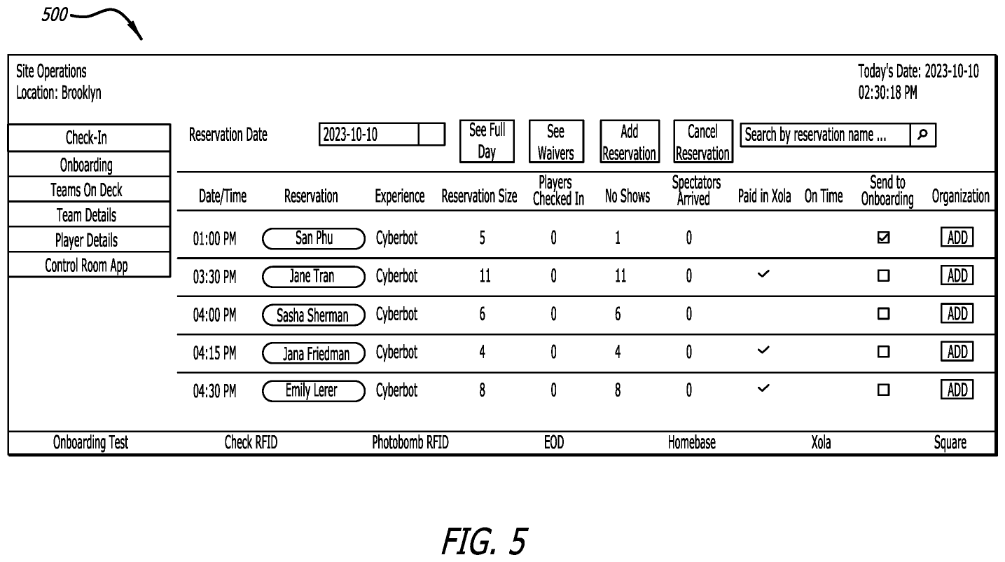

Referring to FIG. 5, a screenshot of a check-in control graphical user interface 500 for an interactive game control logic in accordance with various embodiments of the disclosure is shown. In many embodiments, a check-in control user interface 500 can be utilized to select or otherwise manage a plurality of players available for selection for a team via a graphical user interface for playing in an interactive game room. This selection can be obtained manually from a game technician, or may be generated from a machine-learning process that takes historical data into context. In more embodiments, the historical data may be imported from an external site.

The check-in control graphical user interface (GUI) 500, as depicted in FIG. 5, can serve as a central hub for managing player reservations and team setups in an interactive game facility. The interface is configured to be neatly organized, listing important details about each reservation, such as the player's name, reservation time, game experience, and group size. For example, the first reservation for San Phu at 1:00 PM shows a group size of five players, with one no-show recorded. This streamlined approach can allow game operators to quickly assess which groups are fully checked in and which ones may have attendance issues. The ability to track no-shows and check-ins can ensure that operators can stay on top of player logistics, optimizing the timing and flow of game sessions throughout the day.

In a number of embodiments, the upper section of the check-in control GUI 500 can provide key operational tools that allow for real-time control over the reservation process. Options such as “See Full Day,” “See Waivers,” “Add Reservation,” and “Cancel Reservation” can provide flexibility in managing the daily schedule. For instance, if a last-minute group wants to join a session, the operator can use the “Add Reservation” button to quickly insert them into the system. Similarly, the “Cancel Reservation” option can be used to remove a group that is unable to make their reservation. This functionality can ensure that the game facility can handle dynamic situations and maintain a smooth flow of gameplay for all participants, even on busy days.

The “Send to Onboarding” feature is another critical function that can enhance the efficiency of the check-in process. Once players are checked in, the operator can use the checkbox in this column to initiate the onboarding process. This may involve guiding players through the necessary steps, such as providing them with RFID wristbands, explaining game rules, or directing them to their designated game rooms. In the figure, we can see that San Phu's group has already been sent to onboarding, as indicated by the checkbox in the corresponding column. This feature can help maintain a structured and orderly progression from check-in to gameplay, ensuring that all players are ready to participate without delays.

In some embodiments, the bottom of the interface can include additional tools such as “Onboarding Test,” “Check RFID,” and “Photobomb RFID” are available to assist operators in the technical aspects of the onboarding process. These tools can help ensure that players' RFID tags are functioning correctly and that their identities are properly registered in the system. Furthermore, the interface includes a section to track payments made through the Xola system, as well as the arrival status of each group. By incorporating these details, the system provides comprehensive control over both player management and financial tracking. The check-in control GUI 500, with its intuitive design and detailed functionality, serves as a powerful tool for game operators, allowing them to efficiently manage large groups, ensure smooth onboarding, and maintain a high level of organization within the interactive game facility.

Although a specific embodiment for a check-in control graphical user interface for an interactive game control logic suitable for carrying out the various steps, processes, methods, and operations described herein is discussed with respect to FIG. 5, any of a variety of systems and/or processes may be utilized in accordance with embodiments of the disclosure. For example, the specific layout and functionality of the graphical user interface may be adjusted or otherwise changed based on the application desired. The elements depicted in FIG. 5 may also be interchangeable with other elements of FIGS. 1-4 and 6-16 as required to realize a particularly desired embodiment.

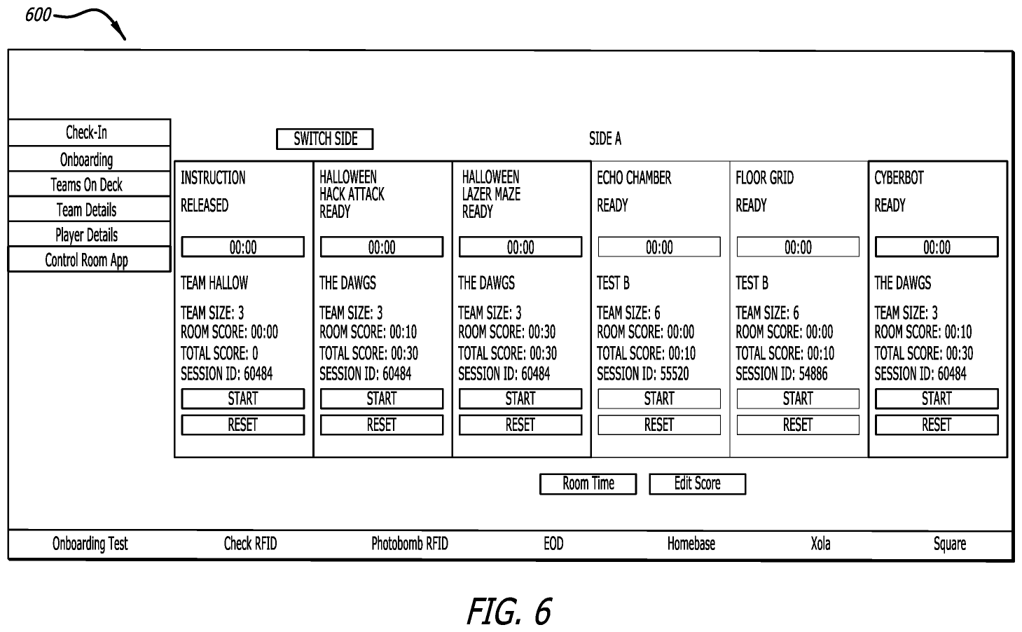

Referring to FIG. 6, a screenshot of a control room graphical user interface 600 for an interactive game control logic in accordance with various embodiments of the disclosure is shown. In many embodiments, a control room graphical user interface 600 can be utilized to select or otherwise manage an interactive game either prior to launch or after its commencement. The game technician may be authorized to stop, restart, or otherwise modify the gameplay for its original gameplay state. This type of control can be inputted manually from a game technician, or may be generated from a machine-learning process that takes historical data into context. In more embodiments, the historical data may be imported from an external site.

The control room graphical user interface (GUI) 600, as depicted in FIG. 6, serves as a powerful tool for game technicians to manage and oversee the operation of interactive games, whether during setup, active gameplay, or post-game adjustments. This control room GUI 600 can provide operators with the ability to closely monitor game sessions, make real-time decisions, and control various aspects of the game's operation. At the core of this control room GUI 600 is its flexibility, allowing game technicians to initiate, stop, pause, or restart games as needed. This level of control can ensure that any potential issues, whether technical or related to player performance, can be addressed promptly to maintain the integrity of the game experience.

In a number of embodiments, a feature of the control room GUI 600 is the ability to manually input commands that affect the gameplay. For example, a technician may need to stop the game in the event of a technical malfunction, or restart a session if players request to begin again from the start. The interface likely includes buttons or controls for these specific functions, offering a streamlined process for executing such commands. This real-time manual control can be utilized in maintaining a seamless gameplay experience, as it allows the operator to intervene when necessary, ensuring that the game progresses as intended without unnecessary interruptions.

In addition to manual inputs, the control room GUI 600 may integrate machine-learning algorithms that provide game operators with suggestions based on historical data from previous game sessions. This data-driven approach allows the system to automatically recommend adjustments to the game's settings, such as altering the game's difficulty or timing, based on how similar games have unfolded in the past. For instance, if previous games have shown that players struggled at a particular stage, the system might suggest extending the time limit or simplifying a task to improve player experience. This combination of real-time control and intelligent automation can help optimize the gameplay experience, ensuring that it remains challenging yet enjoyable for all participants.

Furthermore, the control room GUI 600 may, in certain embodiments, allow historical data to be imported from external sites, giving game operators additional context when making decisions about game management. This external data could include player statistics, game performance metrics, or even broader insights from similar interactive game environments. By leveraging this information, game technicians can tailor the game to the specific players participating, making the experience more personalized and engaging.

Although a specific embodiment for a screenshot of a control room graphical user interface for an interactive game control logic suitable for carrying out the various steps, processes, methods, and operations described herein is discussed with respect to FIG. 6, any of a variety of systems and/or processes may be utilized in accordance with embodiments of the disclosure. For example, the specific layout and functionality of the graphical user interface may be adjusted or otherwise changed based on the application desired. The elements depicted in FIG. 6 may also be interchangeable with other elements of FIGS. 1-5 and 7-16 as required to realize a particularly desired embodiment.

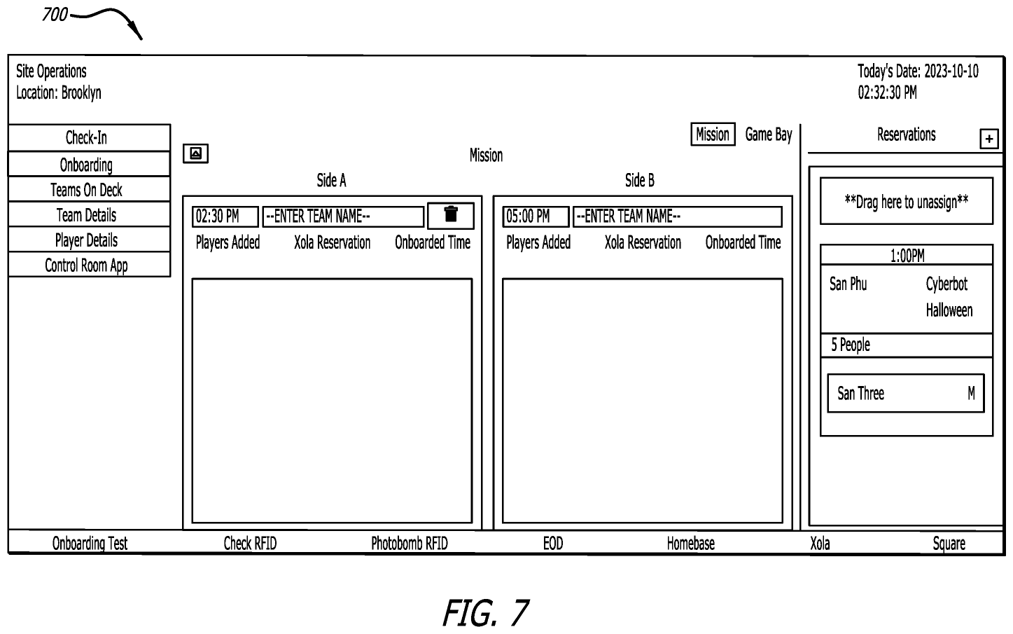

Referring to FIG. 7, a screenshot of a team assignment graphical user interface 700 for an interactive game control logic in accordance with various embodiments of the disclosure is shown. In many embodiments, a team assignment graphical user interface 700 can be utilized to select or otherwise load an interactive game or series of games for a team and assign specific players to each team via a graphical user interface for playing in an interactive game room. This selection can be obtained manually from a game technician, or may be generated from a machine-learning process that takes historical data into context. In more embodiments, the historical data may be imported from an external site.

The team assignment graphical user interface (GUI) 700, as depicted in FIG. 7, can offer a streamlined and efficient tool for game operators to assign players to teams, configure game experiences, and manage reservations for interactive games. In a number of embodiments, the interface is divided into two primary sections, labeled “Side A” and “Side B,” which can represent two teams that will compete against each other. This layout can provide a simple and intuitive way for game operators to manage team assignments. For example, in the “Side A” section, operators can input the team name, assign players, and schedule the game for a specific time, such as “02:30 PM.” A trash icon next to the team name field allows for quick modifications or deletions, adding flexibility in case team changes need to be made at the last minute. This helps to ensure that the game setup process is seamless and adaptable to any situation.

Each side of the team assignment GUI 700 can also track important details related to the team's configuration. For instance, operators can see the number of players added to each team, whether the group has a confirmed reservation, and whether the players have completed the onboarding process. The reservation status can ensure that the group has paid for the session, and the “Onboarded Time” field allows operators to confirm that all players have completed necessary onboarding steps, such as receiving their RFID wristbands and understanding the game rules. For example, if a team on Side B is scheduled for the 5:00 PM game, the operator can ensure that all five players are onboarded and ready to play by checking that the necessary fields are populated.

In more embodiments, features of this interface can include the “Reservations” section (depicted in FIG. 7 on the right side of the screen), where operators can view and manage pending reservations. For example, the reservation for “San Phu” at 1:00 PM, with five players, is displayed alongside the game title “Cyberbot Halloween.” The operator can easily drag this reservation into either Side A or Side B to assign the team to their designated slot. This drag-and-drop functionality can enhance the user experience, allowing operators to quickly and efficiently assign teams without needing to manually enter each player's information. This makes the interface highly adaptable and ensures that games start on time without unnecessary delays.

In additional embodiments, machine learning can play a role in optimizing team assignments and game configurations within this team assignment GUI 700. By analyzing historical data on players' past performances, skill levels, and preferences, the system can automatically suggest team compositions that are balanced and competitive. For instance, if a particular group of players frequently performs well in fast-paced games, the system may recommend assigning them to a challenging game like “Cyberbot Pro” or “Block Monster Semi Final.” Additionally, machine learning algorithms can be configured to identify patterns in player behavior, such as preferences for specific game types or durations, and adjust the game settings accordingly. For example, if historical data shows that a certain team tends to struggle with longer game sessions, the system may recommend shortening the game time to enhance the players' overall experience. This data-driven approach allows the game operator to tailor the experience to the specific needs and preferences of the players, creating a more personalized and engaging gaming experience.

Although a specific embodiment for a screenshot of a team assignment graphical user interface for an interactive game control logic suitable for carrying out the various steps, processes, methods, and operations described herein is discussed with respect to FIG. 7, any of a variety of systems and/or processes may be utilized in accordance with embodiments of the disclosure. For example, the specific layout and functionality of the graphical user interface may be adjusted or otherwise changed based on the application desired. The elements depicted in FIG. 7 may also be interchangeable with other elements of FIGS. 1-6 and 8-16 as required to realize a particularly desired embodiment.

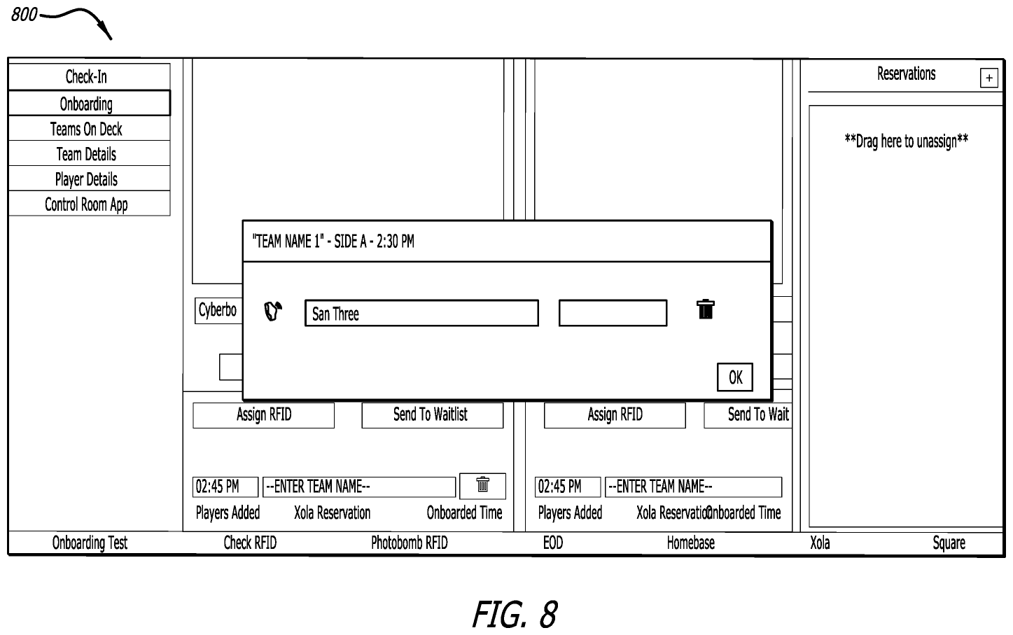

Referring to FIG. 8, a screenshot of a team authorization graphical user interface 800 for an interactive game control logic in accordance with various embodiments of the disclosure is shown. In many embodiments, a team authorization graphical user interface 800 can be utilized to authorize or otherwise verify that a team is correctly assigned to an interactive game room for an interactive game or series of games for a team via a graphical user interface. This selection can be obtained manually from a game technician, or may be generated from a machine-learning process that takes historical data into context. In more embodiments, the historical data may be imported from an external site.

The team authorization graphical user interface (GUI) 800, as depicted in FIG. 8, can offer an intuitive tool for game operators to confirm and manage team assignments before a game session begins. This team authorization GUI 800 can be configured for ensuring that the correct players are assigned to the right teams and that all logistical details are in place prior to gameplay. The pop-up box in the figure displays, for example, “TEAM NAME 1-SIDE A-2:30 PM” with a designated player named “San Three.” This specific field can allow the operator to verify that the player is part of the intended team and game session. If there is an issue, such as an incorrect player assignment, the operator can easily make adjustments using the interface before final authorization is granted.

Additionally, certain embodiments of the team authorization GUI 800 can offer further functionalities for managing players and teams. For example, below the player input field, operators have access to buttons such as “Send to Waitlist” and “Assign RFID.” These options can be useful when certain players or teams cannot immediately participate due to scheduling conflicts or room availability. In some embodiments, if a player arrives late or if the team needs to wait for a room to become available, they can be temporarily placed on a waitlist. Meanwhile, the “Assign RFID” button can allow the operator to link an RFID device to the player, enabling real-time tracking of player performance and participation during the game. This assignment can ensure that all player actions are recorded, providing valuable data on each player's contribution to the game, which can be reviewed later by game operators or for scoring purposes.

In additional embodiments, machine learning can play a role in optimizing the team authorization process by analyzing historical player data and game performance metrics. For example, if the system detects that a particular player has consistently struggled in fast-paced games or has shown a pattern of excelling in cooperative challenges, it may recommend adjusting that player's role or placing them in a team composition that better suits their strengths. Similarly, the system could analyze team dynamics from past games and suggest modifications, such as balancing the teams more effectively or recommending changes to the game format based on the players' prior experiences. This data-driven approach not only enhances team formation but also helps create more engaging and balanced gameplay, ensuring a positive experience for all participants.

Moreover, the team authorization GUI 800 can be designed to integrate external data sources, further enhancing its flexibility and adaptability. For instance, if a player has participated in similar games at different locations or sessions, the system can import that data and use it to inform team assignments and game configurations. This ensures that the game session is tailored to the specific skills and preferences of the players involved. By combining manual team management with machine-learning insights, the team authorization GUI 800 can provide game operators with a robust tool to oversee team setups, optimize player roles, and ensure that gameplay runs smoothly from the moment teams enter the game room. This integration of real-time controls and intelligent suggestions makes it a valuable asset for interactive game environments.

Although a specific embodiment for a screenshot of an interactive game setup graphical user interface 800 for an interactive game control logic suitable for carrying out the various steps, processes, methods, and operations described herein is discussed with respect to FIG. 8, any of a variety of systems and/or processes may be utilized in accordance with embodiments of the disclosure. For example, the specific layout and functionality of the graphical user interface may be adjusted or otherwise changed based on the application desired. The elements depicted in FIG. 8 may also be interchangeable with other elements of FIGS. 1-7 and 9-16 as required to realize a particularly desired embodiment.

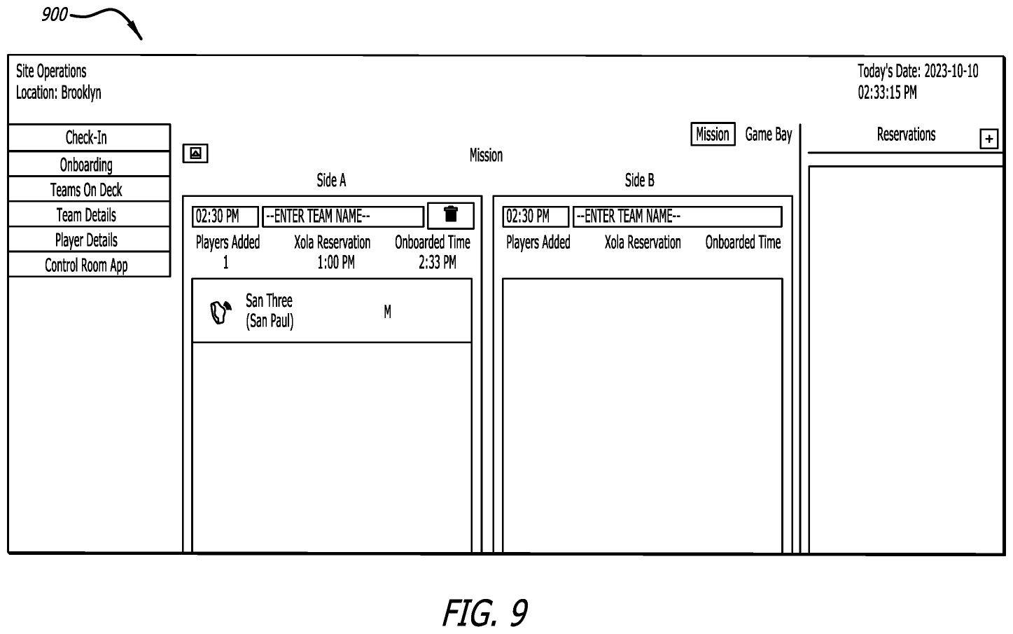

Referring to FIG. 9, a screenshot of a team loading graphical user interface 900 for an interactive game control logic in accordance with various embodiments of the disclosure is shown. In many embodiments, a team loading graphical user interface 900 can be utilized to select or otherwise load teams together via a graphical user interface to play an interactive game. In the embodiment depicted in FIG. 9, the team “San Three” has been assigned and authorized on “Side A” of the interactive game location. This selection can be obtained manually from a game technician, or may be generated from a machine-learning process that takes historical data into context. In more embodiments, the historical data may be imported from an external site.

The team loading graphical user interface (GUI) 900, as shown in FIG. 9 offers an organized and intuitive way for game operators to manage teams and load them into interactive game sessions. This interface plays a vital role in ensuring that players are correctly assigned to their respective teams and prepared for gameplay. In this depicted embodiment, we see that the team “San Three” has been assigned to “Side A” for a 2:30 PM game session. This process can be handled manually by a game technician, but the interface is also designed to integrate machine learning, which can optimize team assignments based on historical data or player preferences. The flexibility in how teams are loaded-either manually or automatically-ensures that the system can accommodate various scenarios, such as last-minute player changes or automatic team balancing.

One of the features of the interface is its ability to provide detailed information about the team and players in a clear and concise manner. In the case of “San Three,” we see not only the player's name, but also an additional identifier (“San Paul”), which could represent the player's full name or their registered ID in the game system. Next to the player's name, a “M” icon is visible, which may indicate a male player or another type of classification relevant to the game. Moreover, the “Xola Reservation” field confirms that the player has a confirmed reservation for the 1:00 PM session, while the “Onboarded Time” field shows that they completed their onboarding at 2:33 PM. These details ensure that operators have a comprehensive view of the team's status, allowing them to verify that all necessary steps have been completed before the game starts.

The ability of the team loading GUI 900 to integrate machine learning can introduce a significant level of intelligence into team formation and game management. For example, by analyzing historical performance data, the system can recommend optimal team assignments that take into account player skills, experience, and preferences. If a particular player has a history of excelling in strategy-based games, the system might recommend placing them in a game session that requires those skills, or it may balance teams by ensuring an even distribution of experienced and novice players. Furthermore, machine learning can predict potential conflicts or inefficiencies in team composition, such as placing two highly competitive players on the same team, and recommend adjustments accordingly. This can help ensure that games remain balanced, competitive, and enjoyable for all participants.

Additionally, the team loading GUI 900 can allow operators to manage multiple teams and game sessions simultaneously, as seen on the right side of the figure. For instance, while “Side A” has been assigned to the “San Three” team, “Side B” is still open for another team to be loaded. This dual-sided setup can enable game operators to efficiently prepare multiple groups for the same session or different ones without needing to navigate away from the interface. The team loading GUI 900 can provide a streamlined, organized approach to managing reservations and player onboarding, with the added benefit of real-time updates for critical details like onboarding time and reservation status. By integrating these functionalities with machine learning-driven suggestions, the system can ensure that teams are not only prepared but also optimized for the best possible gaming experience. This combination of manual control and intelligent automation can offer a highly effective solution for managing interactive games in real-time.

Although a specific embodiment for a screenshot of a team loading graphical user interface for an interactive game control logic suitable for carrying out the various steps, processes, methods, and operations described herein is discussed with respect to FIG. 9, any of a variety of systems and/or processes may be utilized in accordance with embodiments of the disclosure. For example, the specific layout and functionality of the graphical user interface may be adjusted or otherwise changed based on the application desired. The elements depicted in FIG. 9 may also be interchangeable with other elements of FIGS. 1-8 and 10-16 as required to realize a particularly desired embodiment.

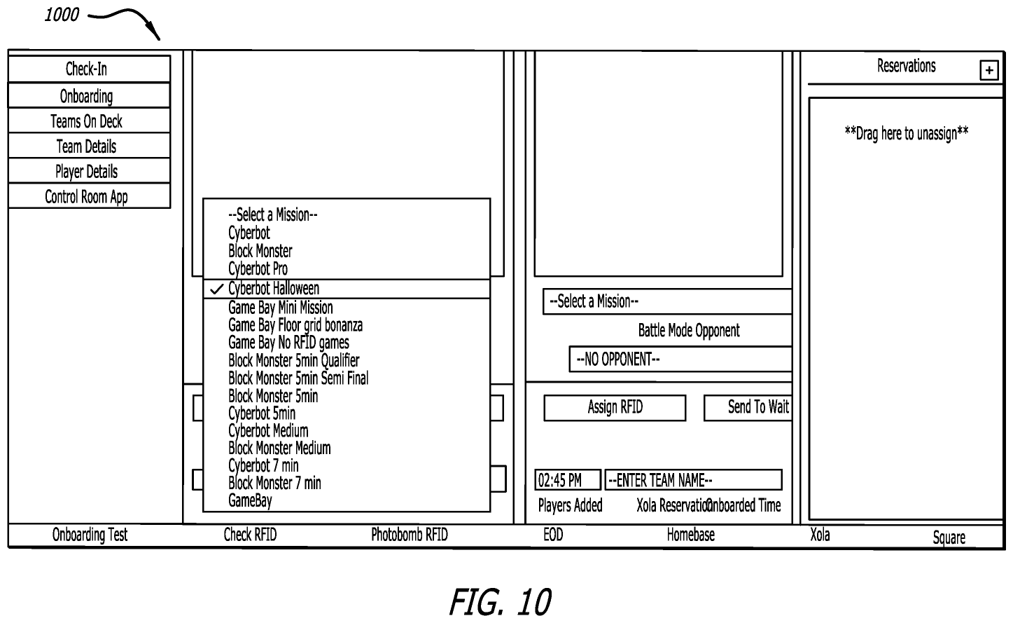

Referring to FIG. 10, a screenshot of a mission selection graphical user interface 1000 for an interactive game control logic in accordance with various embodiments of the disclosure is shown. In many embodiments, a mission selection graphical user interface 1000 can be utilized to select or otherwise load an interactive game or series of games for a team via a graphical user interface for playing in an interactive game room. This selection can be obtained manually from a game technician, or may be generated from a machine-learning process that takes historical data into context. In more embodiments, the historical data may be imported from an external site.

The mission selection graphical user interface (GUI) 1000 depicted in FIG. 10 can serve as a central hub for configuring and assigning interactive game missions to teams within an interactive gaming facility. This system offers game operators a streamlined approach to selecting missions manually or through automated processes based on specific needs. The left panel of the interface can allow operators to choose from various game missions, as seen in the dropdown menu, where “Cyberbot Halloween” has been selected. The dropdown menu can feature numerous other options, such as “Block Monster 5 min Semi Final” and “Game Bay Mini Mission” as in the embodiment of FIG. 10. This flexible selection system can allow game facilitators to tailor the gaming experience to the specific dynamics of each team, ensuring a personalized and engaging experience for players.

The mission selection GUI 1000 can also facilitate the process of managing the overall structure of the game session. Once a mission is selected, additional options such as assigning RFID tags or managing teams can become available. For example, the “Assign RFID” button lets operators link individual players to their respective RFID tags. These tags can enable real-time tracking of player movements, interactions, and participation during the game. With this information, the system can maintain a clear record of which players are involved and ensure that their actions are monitored for scoring and game progression purposes. In this way, the mission selection GUI 1000 can act as a complete control system for managing the logistics of the game environment, ensuring that all necessary data is captured, and all players are accounted for.

In further embodiments, machine learning can play a role in the optimization of this mission selection interface. While previous responses have touched on how historical data can suggest missions based on player performance, this system could also be trained to recognize broader trends in team dynamics. For example, if the system detects that a certain combination of players consistently performs poorly or experiences frustration in cooperative games, it could recommend competitive missions instead. Similarly, machine learning could analyze group patterns to suggest missions with pacing or difficulty levels that match the energy and skill level of the group. These dynamic suggestions could improve the flow and engagement of the game session, ensuring that each team is presented with missions that suit their collective strengths or preferences.

Additionally, the right-hand side of the interface depicted in FIG. 10 is configured with a feature with a “Battle Mode Opponent” configuration. Here, the game operator can manually set up team-versus-team challenges by selecting an opponent from the dropdown menu. Alternatively, the system may automatically assign an opponent or indicate “NO OPPONENT” if no team is available. A unique application of machine learning could come into play by analyzing team performances across multiple sessions to automatically pair teams of comparable skill levels. For example, if the system has observed that two teams frequently compete at a similar level in various missions, it could recommend setting them up as opponents for a more balanced and competitive experience. This smart pairing mechanism could help enhance the enjoyment of competitive modes by ensuring fair matches, adding an extra layer of excitement and engagement for players.

Although a specific embodiment for a screenshot of a mission selection graphical user interface for an interactive game control logic suitable for carrying out the various steps, processes, methods, and operations described herein is discussed with respect to FIG. 10, any of a variety of systems and/or processes may be utilized in accordance with embodiments of the disclosure. For example, the specific layout and functionality of the graphical user interface may be adjusted or otherwise changed based on the application desired. The elements depicted in FIG. 10 may also be interchangeable with other elements of FIGS. 1-9 and 10-16 as required to realize a particularly desired embodiment.

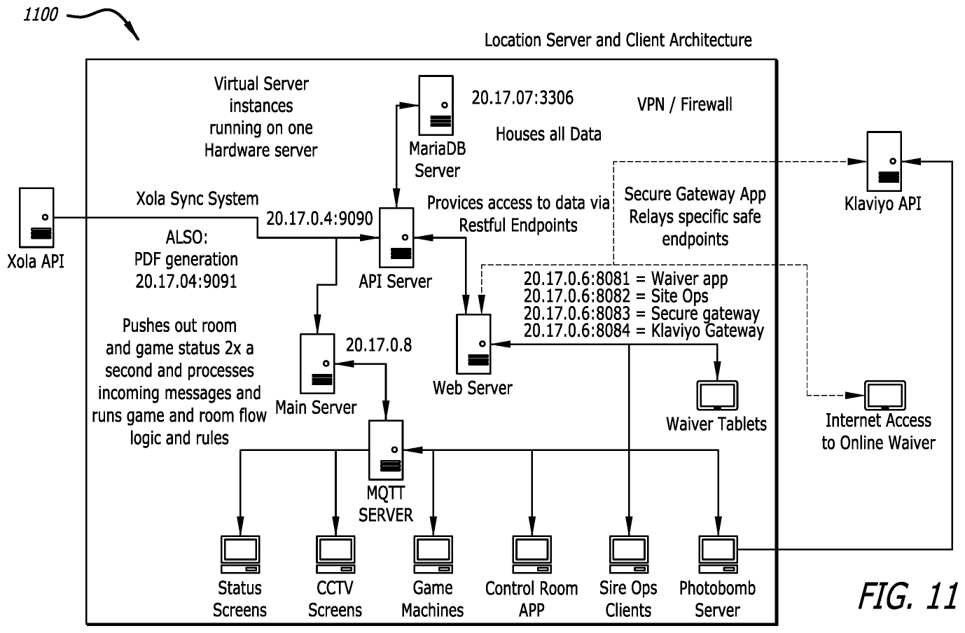

Referring to FIG. 11, a conceptual illustration of a location server and client architecture 1100 for a control game logic in accordance with various embodiments of the disclosure is shown. As can be seen in the embodiment depicted in FIG. 11, various game states, control apps, site ops clients, and other servers and services can be in communication within and in support of an interactive game location. Some of these servers and/or services can be located on premises, but may also be remotely located. The specific location of these servers and/or the vendors providing various services can vary based upon the current network need, cost, and/or the available resources.

The architecture 1100 illustrated in FIG. 11 provides an example of how an interactive game system may be structured to support various gaming environments in interactive game rooms. This architecture could be used to facilitate communication between multiple servers, clients, and external APIs within a location-based interactive game setup. At the center of this design is the Main Server, which may serve as the primary point for processing room and game statuses. These statuses are potentially pushed out as frequently as twice per second, ensuring that all connected systems receive real-time updates on game progression, player activities, and device statuses. By doing so, the architecture supports a smooth, responsive gaming experience where players' interactions with game devices are reflected immediately in the system.

The Main Server may also be responsible for handling incoming messages, processing game rules, and executing room flow logic. It can determine whether game states need to be updated or adjusted based on player activity, allowing for dynamic, real-time gameplay. As described above, game states can comprise at least one or team size, total score, room score, session identification number, team name, associated players, and the like. This central processing unit may be linked to an MQTT server, which could handle communication with various output devices, including status screens, CCTV screens, game machines, and control room applications. The MQTT server may manage real-time messaging and broadcasting, ensuring that all parts of the game environment receive the necessary data to perform their functions effectively.

One of the notable aspects of this architecture is the integration of external APIs, such as the Xola API and Klaviyo API. The Xola API may be used to synchronize reservation data, push updates to the system about players checking in, and generate PDF reports as needed. This type of integration can streamline operations by allowing a single system to handle both the technical aspects of running the games and the logistical aspects, such as managing player reservations and check-ins. Klaviyo API integration may provide additional capabilities, such as sending marketing communications or player notifications, helping to engage players with personalized messages before or after their gaming sessions.

The architecture depicted in FIG. 11 also includes a MariaDB server, which can house all the necessary data for the interactive game system. This database server may store player information, game progress, waiver data, and more, providing a centralized repository for all essential data. The MariaDB server may work in conjunction with an API server, which can provide access to this data via RESTful endpoints. These endpoints could allow external systems or operators to retrieve and update information as needed, such as pulling game statistics for reporting or accessing player waiver data for legal purposes.

One potential use of machine learning within this architecture could involve analyzing the data stored in the MariaDB server. By processing historical data on player behavior, game outcomes, and equipment performance, machine learning algorithms could be employed to predict future trends and optimize game configurations. For example, machine learning could be used to recommend games or room configurations that have historically resulted in higher player engagement and satisfaction.

The Web Server can be another key component in this architecture, potentially managing web-based interactions such as online waiver submissions and player onboarding. This server may interface with waiver tablets within the facility, allowing players to sign digital waivers before participating in the games. By handling this process digitally, the system could reduce the need for paper forms, streamline the check-in process, and ensure that waiver data is securely stored and accessible in the MariaDB server. The Secure Gateway App can act as a relay for safe communication between the Web Server and external endpoints, maintaining security protocols while transmitting sensitive data, such as player personal information.

In addition to game operations, the system may support facility management through various site operation clients and control room applications. These clients could provide game operators with real-time data on the status of the games, room occupation, and player progress. Operators may be able to control various aspects of the game flow, such as pausing or restarting games, assigning new players to teams, or monitoring game room activity via CCTV screens. The control room app could offer a comprehensive view of all game activities within the facility, enabling operators to manage the experience efficiently from a centralized location. In some embodiments the control room application can be configured to allow for suspension, termination, and/or ending the game in progress or upon completion. This process can be controlled by one or more game control logics. In more embodiments, the control room application can be configured to operate on one or more game components or interactive game room devices.

Another potential application of machine learning within this system could be predictive maintenance. Given that the Main Server pushes game and room statuses multiple times per second, machine learning models could be used to monitor this continuous stream of data to identify patterns that may indicate potential issues with game machines or other equipment. By analyzing these patterns, the system could predict when a game machine is likely to malfunction, allowing operators to perform maintenance before a failure occurs. This proactive approach could minimize downtime and ensure that the gaming environment remains fully operational for players.

The Photobomb Server, integrated into the system, may offer additional interactive features, such as capturing and storing photos or videos of players during the games, such as during the final bomb room with the ejection device. This server could work in tandem with other parts of the system, such as the Web Server or MariaDB server, to store these media files securely. These images and videos could then be accessed by players or facility staff for sharing, printing, or viewing, enhancing the overall player experience by allowing participants to take home a tangible memory of their gameplay. Overall, the architecture depicted in FIG. 11 demonstrates a robust, interconnected system that could support a wide range of gaming activities and administrative functions. Through the use of APIs, data storage, machine learning, and real-time communication protocols, this system has the potential to provide both an engaging gaming experience for players and efficient operational management for game operators.

Although a specific embodiment for a location server and client architecture for a control game logic suitable for carrying out the various steps, processes, methods, and operations described herein is discussed with respect to FIG. 11, any of a variety of systems and/or processes may be utilized in accordance with embodiments of the disclosure. For example, as those skilled in the art will recognize, the specific layout, architecture, and/or devices or services utilized may vary or otherwise be changed depending on the application desired. The elements depicted in FIG. 11 may also be interchangeable with other elements of FIGS. 1-10 and 12-16 as required to realize a particularly desired embodiment.

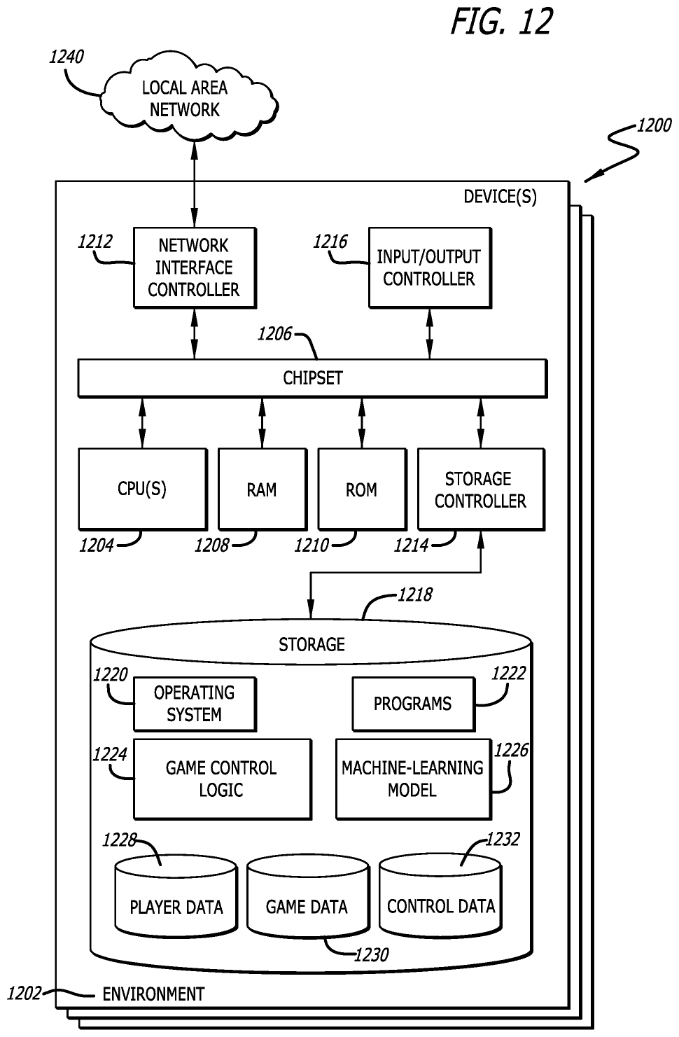

Referring to FIG. 12, a conceptual block diagram of a device 1200 suitable for configuration with a game control logic 1224, in accordance with various embodiments of the disclosure is shown. The embodiment of the conceptual block diagram depicted in FIG. 12 can illustrate a conventional game device, personal computer, mobile game device, game server, laptop, tablet, network appliance, e-reader, smartphone, wearable device, or other computing device, and can be utilized to execute any of the application and/or logic components presented herein. The device 1200 may, in many non-limiting examples, correspond to physical devices or to virtual resources described herein.

In many embodiments, the device 1200 may include an environment 1202 such as a baseboard or “motherboard,” in physical embodiments that can be configured as a printed circuit board with a multitude of components or devices connected by way of a system bus or other electrical communication paths. Conceptually, in virtualized embodiments, the environment 1202 may be a virtual environment that encompasses and executes the remaining components and resources of the device 1200. In more embodiments, one or more processors 1204, such as, but not limited to, central processing units (“CPUs”) can be configured to operate in conjunction with a chipset 1206. The processor(s) 1204 can be standard programmable CPUs that perform arithmetic and logical operations necessary for the operation of the device 1200.

In a number of embodiments, the processor(s) 1204 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1206 may provide an interface between the processor(s) 1204 and the remainder of the components and devices within the environment 1202. The device 1200 can incorporate different types of processors to enhance performance and efficiency across various tasks. A central processing unit (CPU) can handle primary processing tasks such as game logic, AI, and player inputs, while a graphics processing unit (GPU) can be specialized for rendering high-resolution graphics and visual effects. Digital signal processors (DSPs) may manage audio processing, delivering high-quality sound without burdening the CPU. In portable devices, systems on a chip (SoCs) can be configured to integrate the CPU, GPU, memory, and peripherals to balance performance and efficiency. In some embodiments, application-specific integrated circuits (ASICs) can optimize specific functions like cryptographic processing, while neural processing units (NPUs) accelerate AI and machine learning tasks. Some high-end devices may also include physics processing units (PPUs) to handle complex physics calculations, further enhancing the realism and responsiveness of the gaming experience. However, those skilled in the art will recognize that the device 1200 can any variety or combination of processor(s) 1204 as needed to satisfy the desired application.

The chipset 1206 can provide an interface to a random-access memory (“RAM”) 1208, which can be used as the main memory in the device 1200 in some embodiments. The chipset 1206 can further be configured to provide an interface to a computer-readable storage medium such as a read-only memory (“ROM”) 1210 or non-volatile RAM (“NVRAM”) for storing basic routines that can help with various tasks such as, but not limited to, starting up the device 1200 and/or transferring information between the various components and devices. The ROM 1210 or NVRAM can also store other application components necessary for the operation of the device 1200 in accordance with various embodiments described herein.

Additional embodiments of the device 1200 can be configured to operate in a networked environment using logical connections to remote computing devices and computer systems through a network, such as the local area network 1240. The chipset 1206 can include functionality for providing network connectivity through a network interface controller (“NIC”) 1212, which may comprise a gigabit Ethernet adapter or similar component. The NIC 1212 can be capable of connecting the device 1200 to other devices over the local area network 1240. It is contemplated that multiple NICs 1212 may be present in the device 1200, connecting the device to other types of networks and remote systems, such as the Internet.

In further embodiments, the device 1200 can be connected to a storage 1218 that provides non-volatile storage for data accessible by the device 1200. The storage 1218 can, for instance, store an operating system 1220, and/or game engine 1222. In various embodiments, the storage 1218 can be connected to the environment 1202 through a storage controller 1214 connected to the chipset 1206. In certain embodiments, the storage 1218 can consist of one or more physical storage units. The storage controller 1214 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

In additional embodiments, the device 1200 can store data within the storage 1218 by transforming the physical state of the physical storage units to reflect the information being stored. The specific transformation of physical state can depend on various factors. Examples of such factors can include, but are not limited to, the technology used to implement the physical storage units, whether the storage 1218 is characterized as primary or secondary storage, and the like.

In many more embodiments, the device 1200 can store information within the storage 1218 by issuing instructions through the storage controller 1214 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. In some embodiments, the device 1200 can further read or access information from the storage 1218 by detecting the physical states or characteristics of one or more particular locations within the physical storage units.

In addition to the storage 1218 described above, certain embodiments of the device 1200 may also have access to other computer-readable storage media to store and retrieve information, such as program modules, data structures, or other data. It should be appreciated by those skilled in the art that computer-readable storage media is any available media that provides for the non-transitory storage of data and that can be accessed by the device 1200. In some examples, operations performed by a cloud computing network, and or any components included therein, may be supported by one or more devices similar to device 1200. Stated otherwise, some or all of the operations performed by the cloud computing network, and or any components included therein, may be performed by one or more devices 1200 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1218 can store an operating system 1220 utilized to control the operation of the device 1200. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1218 can store other system or application programs and data utilized by the device 1200.

In many additional embodiments, the storage 1218 or other computer-readable storage media is encoded with computer-executable instructions which, when loaded into the device 1200, may transform it from a general-purpose computing system into a special-purpose computer capable of implementing the embodiments described herein. These computer-executable instructions may be stored as application and transform the device 1200 by specifying how the processor(s) 1204 can transition between states, as described above. In some embodiments, the device 1200 has access to computer-readable storage media storing computer-executable instructions which, when executed by the device 1200, perform the various processes described above with regard to FIGS. 1-11 and 13-16. In certain embodiments, the device 1200 can also include computer-readable storage media having instructions stored thereupon for performing any of the other computer-implemented operations described herein.

In a number of embodiments, the device 1200 can store a game engine 1222 in storage 1218 and load it when the game is launched, enabling quick access and execution. The game engine 1222 can manage core tasks such as rendering graphics, processing inputs, handling physics calculations, and managing audio by leveraging the device's CPU, GPU, and other hardware components. It can abstract hardware complexities to ensure smooth gameplay and real-time interaction. Additionally, in various embodiments, the game engine 1222 cam facilitate network communications for multiplayer interactions and supports cross-platform functionality, allowing games to run efficiently on various devices within the available game ecosystem.

In many embodiments, the device 1200 can include a game control logic 1224 that can be configured to perform one or more of the various steps, processes, operations, and/or other methods that are described above. Often, the game control logic 1224 can be a set of instructions stored within a non-volatile memory that, when executed by the processor(s)/controller(s) 1204 can carry out these steps, etc. In some embodiments, the game control logic 1224 may be a client application that resides on a network-connected device, such as, but not limited to, a server, switch, personal or mobile computing device. In certain embodiments, the game control logic 1224 can direct the availability and execution of control interface items within an interactive game room.

However, in additional embodiments, the game control logic 1224 can generate various scores and metrics with data provided by the players and/or a series of game components within the multi-purpose interactive game room. In further embodiments, the game control logic 1224 may also generate or otherwise facilitate the creation of proposed games available for play based on the available series of game components deployed or otherwise working in the room. In some embodiments, the game components can be connected to via at least a network connection, which can allow for control by the game control logic 1224. In still more embodiments, the game control logic 1224 can evaluate a proposed game selection based on the one or more scores and data sources available. Finally, in certain embodiments, the game control logic 1224 can select and apply an updated sustainable configuration to the network by directing one or more planes to de-energize and/or re-energize.

In some embodiments, player data 1228, stored within the system's storage 1218, may serve as a key component for enhancing the interactive gaming experience. This player data 1228 may encompass various elements such as player names, team names, preferred colors, and historical play data, all of which can be used to personalize gameplay. For example, teams may be assigned based on historical performance or preferences, allowing for a more tailored experience that can increase player engagement. The data may also include other identifying information, such as game preferences or even scores from previous sessions, which can help the system provide recommendations for future games. This player data 1228 may be captured through several means, including player entry on a mobile computing device, intake tablets, or other digital interfaces during the onboarding process. By capturing this information in real time, the system could allow for smooth integration into the game environment, instantly updating game settings, team configurations, and other elements based on the player profiles. The ability to track and store this data over time also opens the door to future integrations with machine learning algorithms, which could analyze this information to predict player behavior, suggest games that match their skill level, or even identify potential team combinations for enhanced cooperative gameplay.

In various embodiments, game data 1230, stored in the system's storage 1218, may represent an element in configuring and managing interactive game rooms. This data can include information gathered from a variety of game components, such as sensors, which may be embedded in the room's physical infrastructure. These sensors may track a range of activities within the game room, including player movements, interactions with specific game elements, or even changes in the game environment. The data generated by these sensors can then be processed by the game logic, enabling it to update the current game state dynamically. For instance, as players engage with certain game objects or complete tasks, the system may adjust game difficulty, unlock new levels, or trigger in-game events that are tied directly to player behavior. Additionally, the game data 1230 can be associated with individual players or teams, allowing for real-time feedback and personalized game mechanics. This may include tailoring the game flow based on the player's past performance or actions during the session. As this data accumulates, machine learning algorithms could further enhance the experience by identifying patterns and adapting future game states to optimize challenge levels or improve the overall engagement of the players. This adaptive element allows for more immersive and continuously evolving gameplay, providing a richer experience for the users.

In many embodiments, control data 1232 stored in system storage 1218 may serve as a crucial aspect of managing an interactive game room. This data may define the types of controls available to a game technician or user at any given moment. The level of control may be tailored according to the role and authorization level of the technician or operator, ensuring that only authorized personnel can execute critical commands, such as resetting a game, altering the game's difficulty, or overriding in-game events. For instance, a higher-level technician may have full access to all system controls, including the ability to modify game logic, while a lower-level technician or employee may be limited to basic operational functions, such as starting or stopping games. The control data 1232 may also be specific to the game type being played; certain games may require more granular control, such as activating or deactivating specific game components, while others may allow for simpler game management commands. Furthermore, the control data 1232 can dynamically adjust based on the game's progress, enabling or disabling certain actions as the game advances to different stages. This flexibility in control options can optimize gameplay management, ensuring that technicians have access to the appropriate tools without overcomplicating the user interface. Machine learning could potentially analyze how technicians interact with the control system to improve control access or recommend specific actions during gameplay, creating a more seamless and efficient game operation process.

In still further embodiments, the device 1200 can also include one or more input/output controllers 1216 for receiving and processing input from a number of input devices, such as a keyboard, a mouse, a touchpad, a touch screen, an electronic stylus, or other type of input device. Similarly, an input/output controller 1216 can be configured to provide output to a display, such as a computer monitor, a flat panel display (which may be part of an interactive game room component/device), a digital projector, a printer, or other type of output device. Those skilled in the art will recognize that the device 1200 might not include all of the components shown in FIG. 12 and can include other components that are not explicitly shown in FIG. 12 or might utilize an architecture completely different than that shown in FIG. 12.

As described above, the device 1200 may support a virtualization layer, such as one or more virtual resources executing on the device 1200. In some examples, the virtualization layer may be supported by a hypervisor that provides one or more virtual machines running on the device 1200 to perform functions described herein. The virtualization layer may generally support a virtual resource that performs at least a portion of the techniques described herein.

Finally, in numerous additional embodiments, data may be processed into a format usable by one or more machine-learning models 1226 (e.g., feature vectors), and or other pre-processing techniques. The machine-learning (“ML”) models 1226 may be any type of ML model, such as supervised models, reinforcement models, and/or unsupervised models. The ML models 1226 may include one or more of linear regression models, logistic regression models, decision trees, Naïve Bayes models, neural networks, k-means cluster models, random forest models, and/or other types of ML models 1226.

The ML model(s) 1226 can be configured to generate inferences to make predictions or draw conclusions from data. An inference can be considered the output of a process of applying a model to new data. This can occur by learning from at least the player data 1228, the game data 1230, and/or the control data 1232. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a set of coordinates within a three-dimensional space, a probability distribution, a set of labels/characteristics/parameters, a decision about an action to take, etc. Ground truth for the ML model(s) 1226 may be generated by human/administrator verifications or may compare predicted outcomes with actual outcomes.

Although a specific embodiment for a device suitable for configuration with the full control camera logic suitable for carrying out the various steps, processes, methods, and operations described herein is discussed with respect to FIG. 12, any of a variety of systems and/or processes may be utilized in accordance with embodiments of the disclosure. For example, the device 1200 may be in a virtual environment such as a cloud-based game administration environment, or it may be distributed across a variety of network devices or servers. The elements depicted in FIG. 12 may also be interchangeable with other elements of FIGS. 1-11 and 13-16 as required to realize a particularly desired embodiment.

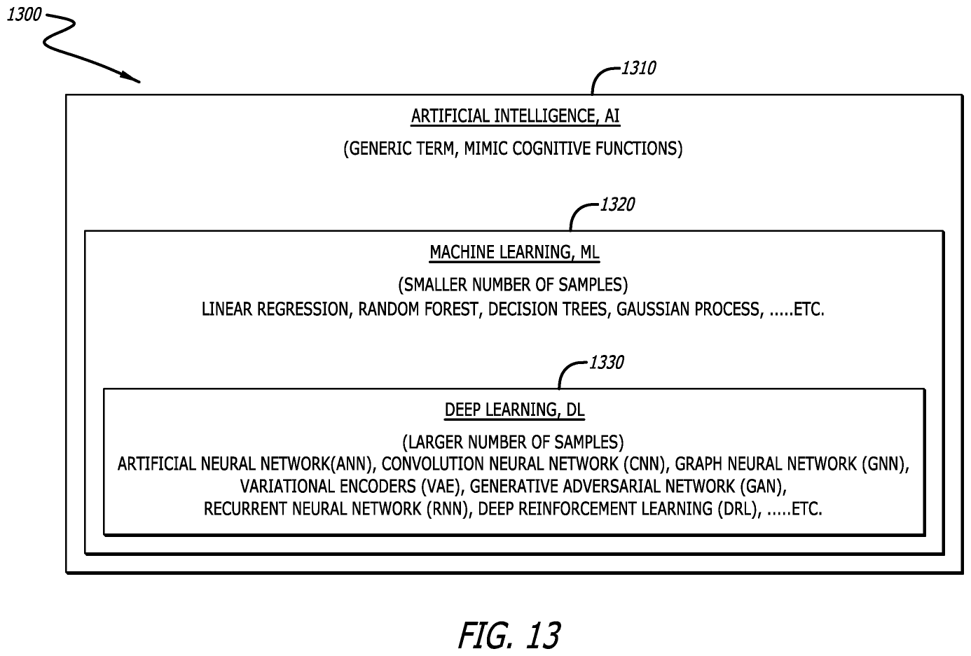

Referring to FIG. 13, a diagram 1300 depicting various subsets of artificial intelligence in accordance with various embodiments of the disclosure is shown. Artificial intelligence (AI) 1310 is typically understood in the art to be the development of machines and algorithms that mimic human intelligence, for example, by optimizing actions to achieve certain goals. At its core, AI 1310 often involves designing algorithms and models that mimic cognitive functions, such as learning, reasoning, problem-solving, perception, and even language understanding. Unlike traditional computer programs that follow a fixed set of instructions, AI systems have the ability to adapt, improve, and make decisions based on input data and environmental interactions.

AI 1310 can be considered a generic term because it encompasses a wide range of subfields and techniques, from simple rule-based systems to advanced machine learning and deep learning models. These AI techniques are used to simulate various aspects of human cognition. For example, machine learning (ML) 1320 allows computers to learn from data patterns without explicit programming for each task, while natural language processing (NLP) enables machines to understand and generate human language. Deep learning (DL) 1330, a more advanced branch of AI, uses neural networks to automatically learn complex patterns from large datasets, akin to the human brain's information processing. This versatility makes AI a powerful tool across diverse applications, including image recognition, autonomous driving, voice assistants, healthcare diagnostics, and materials discovery.

A goal of AI is often to create systems that can function autonomously and intelligently in real-world scenarios. As AI 1310 continues to evolve, it can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

Machine Learning (ML) 1320 is a subset of Artificial Intelligence (AI) 1310 that focuses on the development of algorithms and statistical models that enable computers to learn and make decisions from data without explicit programming. In traditional programming, a computer is given a fixed set of rules to follow, but ML 1320 can shift this paradigm by allowing systems to identify patterns, adapt, and improve their performance based on the data they encounter. This data-driven approach makes ML particularly valuable for tasks that are too complex or dynamic to define using straightforward rules, such as, for example, recognizing images, predicting consumer behavior, or diagnosing diseases. In various embodiments described herein, machine-learning methods may be utilized to control the selection, operation, or other aspects about operating an interactive game facility.

ML models can be configured to analyze large amounts of data to identify trends and relationships that inform their predictions or classifications. The process typically involves three stages: training, validation, and testing. During training, the model learns from a dataset by adjusting its internal parameters to minimize errors between its predictions and the actual results. Techniques like linear regression, decision trees, random forests, and Gaussian processes are commonly used in ML 1320. These algorithms can handle various data types, including numerical, categorical, and structured datasets like spreadsheets or grids. One of the key strengths of ML is its ability to generalize from the training data to make accurate predictions on new, unseen data. In a number of embodiments described herein, training data may be generated from historical player data, operator inputs, quality assurance/testing feedback, among other sources.

However, traditional ML methods rely heavily on feature engineering, wherein human experts manually identify the most relevant features or patterns within the data. For example, when using ML 1320 for image recognition, an expert might need to extract features like edges, textures, or color patterns before feeding them into a model. This requirement can limit the scalability of traditional ML approaches, especially when dealing with large, unstructured datasets such as images, text, or graphs. Additionally, ML algorithms may often work best when provided with relatively structured data, and they often need a reasonable amount of samples (typically more than 100) to learn effectively.

Deep Learning (DL) 1330 is a specialized subset of Machine Learning (ML) 1320 that employs multi-layered artificial neural networks to automatically learn complex patterns and representations from large, often unstructured datasets. Inspired by the way the human brain processes information, DL 1330 consists of interconnected layers of “neurons” that can adaptively change as they are exposed to more data. Unlike traditional ML methods, which require manual feature engineering to identify key data characteristics, DL models can automatically extract features directly from raw data, such as images, text, or molecular structures. This automated feature extraction allows DL 1330 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as molecular structures, social networks, or atomic interactions. They can learn the dependencies and relationships within graph-like structures, which is crucial for predicting properties of complex molecules and materials. RNNs and their variants, such as Long Short-Term Memory (LSTM) networks, are suited for sequential data like time series or natural language processing, allowing for the analysis and generation of textual information or the prediction of temporal patterns in scientific research.

One of the defining characteristics of deep learning is its requirement for large datasets (typically over 500 samples for example) to effectively train neural networks. The deep, multi-layered structure of these networks enables them to capture highly complex and abstract representations of the data, but it also demands significant computational power. Techniques like Variational Autoencoders (VAEs) and Generative Adversarial Networks (GANs) add to the versatility of DL by enabling the generation of new data samples that resemble the training set, aiding in areas such as materials discovery and synthetic data creation. Deep Reinforcement Learning (DRL) combines neural networks with decision-making processes to solve problems that involve optimization and control, further expanding DL's application potential. In summary, DL's ability to automatically learn from raw, unstructured data and model intricate patterns makes it a powerful tool in AI, particularly for complex domains like image recognition, natural language processing, and materials science.

Artificial Neural networks (ANNs or sometimes just NNs) are often a foundation of a DL system. The basic unit of a neural network is typically the perceptron, which can take inputs, assigns weights to these inputs, and combines them to produce an output. The final output is then passed through an activation function (such as, for example, ReLU, sigmoid, or hyperbolic tangent) to introduce non-linearity, which enables the network to model complex patterns.

Neural networks are typically trained through a process of backpropagation, where the system's predictions are compared against the known output, and a loss function is used to measure the difference between the prediction and the actual result. The network's weights can be adjusted through a process called gradient descent, which can be configured to minimize the loss function over time. However, the training process can be prone to problems like overfitting (where the model performs well on the training data but poorly on new data). To counter this, techniques such as regularization (e.g., regularization, dropout), early stopping, and mini-batches can be utilized to prevent the network from becoming overly specialized to the training set.

CNNs are a specific type of ML 1330 neural network designed to work particularly well with image data, making them highly relevant for as image data can be generated within an interactive game room from cameras and the like and thus be subject to processing. As those skilled in the art will recognize, CNNs typically use specialized layers known as convolutional layers, which apply filters (also known as kernels) to the input data. These filters slide over the input (e.g., an image), detecting patterns like edges or textures, which are then passed to the next layer for further processing. The advantage of CNNs is their ability to automatically learn and extract relevant features from raw data without the need for manual feature engineering. Furthermore, pooling layers (e.g., max-pooling or average pooling) are often added after convolutional layers to reduce the dimensionality of the data, helping to make the system more efficient while retaining the most important information. After several layers of convolutions and pooling, the CNN can output a prediction, such as classifying an image or generating a score suitable for evaluation for an interactive game.

While CNNs are well-suited for grid-based data like images, many real-world problems in can involve non-grid data, such as player/asset locations, interactive game rules, or player/device interactions. This type of data may better be represented as a graph, where nodes represent entities (e.g., players) and edges represent relationships between them (e.g., other players/unique gameplay devices, etc.). Thus, Graph Neural Networks (GNNs) can be utilized to operate on such graph-based data.

In GNNs, information is passed between nodes through edges in a process called message passing. This allows the network to capture dependencies and relationships within the graph structure. The key feature of GNNs is their ability to aggregate information from neighboring nodes, which is crucial in predicting properties that depend on the current/local structure, such as the behavior of a player or the properties of an interactive game room.

Generative models aim to learn the underlying distribution of a dataset and generate new samples that resemble the original data. Two common types of generative models are Variational Autoencoders (VAEs) and Generative Adversarial Networks (GANs). VAEs are often configured to work by encoding data into a lower-dimensional latent space and then decoding it back into its original form. This allows for the generation of new data by sampling points from the latent space. This can be utilized when attempting to construct fair teams for play in a series of interactive game rooms or the like.

Similarly, GANs consist of two components: a generator that creates fake/generated data and a discriminator that tries to distinguish between real and fake data. The two components are trained in a competitive process where the generator tries to “fool” the discriminator, leading to increasingly realistic generated data. This type of process may be utilized to compare player scores and potential alternative team arrangements, etc.

Reinforcement Learning (RL) involves an agent learning to make decisions by interacting with an environment and receiving feedback (rewards or penalties) based on its actions. Deep Reinforcement Learning (DRL) combines RL with DL techniques, allowing agents to learn from high-dimensional inputs, such as images or complex gameplay simulations.

In interactive games, DRL can be used in scenarios where an optimal decision needs to be made, such as optimizing game selections or finding the best configuration for one or more teams based on the desired or current properties of the interactive game room options. The combination of RL and DL can allow for learning from raw data, making it a powerful tool for dynamic and real-time decision-making within an interactive game.

Although a specific embodiment for a diagram 1300 depicting various subsets of artificial intelligence suitable for carrying out the various steps, processes, methods, and operations described herein is discussed with respect to FIG. 13, any of a variety of systems and/or processes may be utilized in accordance with embodiments of the disclosure. For example, other subset may be present and available for use within AI 1310. Those skilled in the art will recognize that the diagram 1300 presented in FIG. 13 is simplified for illustration purposes and various methods and techniques may interact with other areas (ML 1320 with DL 1330, etc.). The elements depicted in FIG. 13 may also be interchangeable with other elements of FIGS. 1-12 and 14-16 as required to realize a particularly desired embodiment.

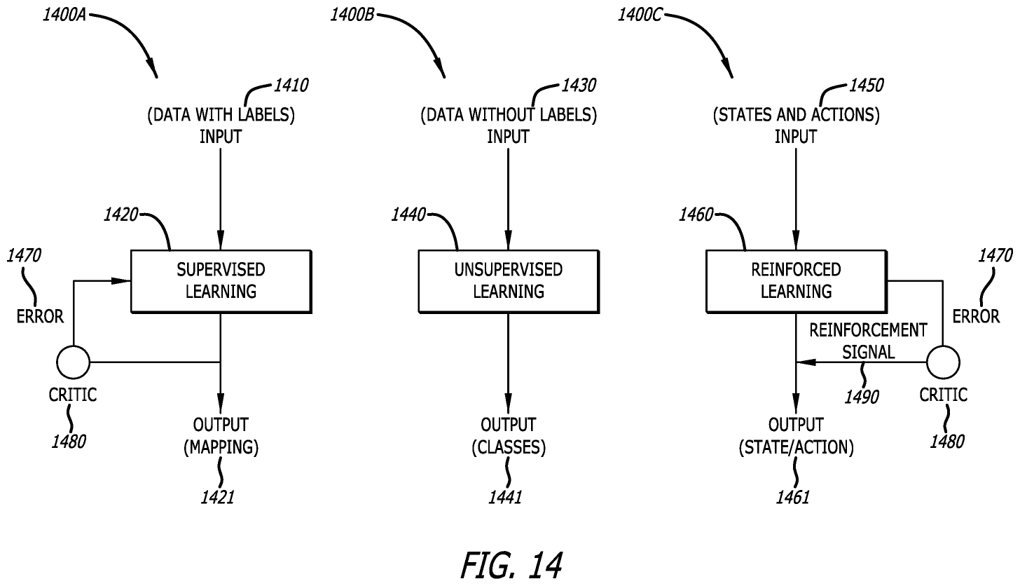

Referring to FIG. 14, different methods of machine-based learning in accordance with various embodiments of the disclosure are shown. In many embodiments, a machine learning model is defined as a mathematical representation of the output of the training process. A machine learning model is often considered similar to computer software designed to recognize patterns or behaviors based on previous experience or data. However, the learning algorithm can discover patterns within the training data, and output an ML model which can capture these patterns and make predictions on new data.

ML models can be understood as a device that has been trained to find patterns within new data and make predictions. These models can be represented as a complex mathematical function that would be impractical for a human to calculate that takes requests in the form of input data, makes predictions on input data, and then provides an output in response. First, these models can be trained over a set of data, and then they are provided an algorithm or other task to reason over data, extract the pattern from feed data and learn from that data. Once the model(s) is/are trained, they can be used to predict a new and previously unseen dataset.

There are various types of machine learning models available based on different business goals and data sets available. Often, based on the desired application, ML models can be configured as or settle into one of three different model types: supervised learning, unsupervised learning, and/or reinforcement learning. Supervised learning can further be broken down into two categories of classification and regression. Likewise, unsupervised learning can be divided into three categories: clustering, association rule, and/or dimensionality reduction.

In the embodiment depicted in FIG. 14, a supervised learning system 1400A is shown. The supervised learning system 1400A can be configured with a supervised learning model 1420 that accepts input data 1410 and generates an output 1421. However, the output data is often reviewed by a critic 1480 that can determine one or more errors 1470 that are fed back into the supervised learning model 1420 for use in updating.

Supervised learning systems 1400A are often considered the simplest machine learning model to understand in which input data (such as training data) has a known label or result as an output. So, the supervised learning model 1420 can be understood to work on the principle of input-output pairs. As such, a function can be trained using a training data set, which is then applied to unknown data and makes some predictive performance. Supervised learning is task-based and mostly tested on labeled data sets.

Supervised learning systems 1400A may often involve one or more regression problems. In regression problems, the output is a continuous variable. Some commonly used Regression models include linear regression, decision trees, and random forests. Linear regression is typically the most straight forward machine learning model in which a prediction of one output variable is made using one or more input variables. The representation of linear regression can be processed as a linear equation, which combines a set of input values (denoted as x) and a predicted output (denoted as y) for the set of those input values. As those skilled in the art will recognize, this may be represented in the form of a line: Y=bx+c. A typical aim of a linear regression-based model can be to find the optimal fit line that best fits the available data points. Linear regression can be extended to multiple linear regressions (finding a plane of best fit in higher dimensional space) and polynomial regressions (finding the best fit curve).

Decision trees are also popular machine learning models that can be used for both regression and classification problems. A decision tree uses a tree-like structure of decisions along with their possible consequences and outcomes. In this, each internal node is used to represent a test on an attribute while each branch is used to represent the outcome of the test. The more nodes a decision tree has, the more accurate the result will be. This may be used when making decisions related to various game selections and the resulting score of the teams. The advantage of decision trees is that they are intuitive and easy to implement, but may lack accuracy depending on the available computational or time resources available.

Random forests are an ensemble learning method, which may consist of a large number of decision trees. For example, each decision tree in a random forest predicts an outcome, and the prediction with the majority of votes is considered as the outcome. A random forest model can be used for both regression and classification problems. For the classification task, the outcome of the random forest may be taken from the majority of votes. Whereas in the regression task, the outcome can be taken from the mean or average of the predictions generated by each tree.

Classification models are another type of supervised learning, which can be used to generate conclusions from observed values in one or more categorical forms. For example, a classification model can identify if an email is spam or not; whether a player is cheating or not, etc. Classification algorithms can also be used to predict between two or more classes and/or categorize an output into different groups. For these classification systems, a classifier model can be designed that classifies the dataset into different categories, and each category can subsequently be assigned a label. As those skilled in the art will recognize, there are currently two main types of classifications in machine learning: binary and multi-class. Binary classification can be utilized when there are only two possible classes (i.e., yes/no, dog/cat, etc.). Multi-class classification can be utilized when there are more than two possible classes, thus requiring a multi-class classifier.

One of the potential classification processes is logistic regression. Logistic regression can be used to solve various classification problems in machine learning systems. These processes are similar to linear regression but are often used to predict categorical variables. While some variations can be configured to generate a prediction as an output in either “yes” or “no”, 0 or 1, “true” or “false”, etc. However, in some embodiments, the system can instead be configured to not give exact values, but instead provide probabilistic values between zero and one, etc.

Another classification process that can be utilized is a support vector machine (SVM) which is widely used for classification and regression tasks. However, the main aim of SVM is to find the best decision boundaries in an N-dimensional space, which can be utilized to segregate data points into classes, and generate a best decision boundary often known as a hyperplane. SVM processes can select the extreme vector to find a hyperplane, wherein these vectors are known as support vectors.

Naïve Bayes is another popular classification algorithm used in machine learning. This process receives its name as it is based on Bayes theorem and follows the naïve (independent) assumption between the features which is often given as the formula:

$$P ( y \vert X ) = \frac{P ( X \vert y ) * P ( y )}{P ( X )}$$

This formula takes a class or target y and a predictor attribute (X) and calculates a posterior probability P (y|X) of that class given a particular predictor. P (y) is the prior probability of that class, P (X) is the prior probability of the predictor, and P (X|y) is the likelihood or probability of the predictor given the class. As those skilled in the art will recognize, this may be more succinctly understood as the posterior chance being a result of the prior results times the likelihood divided by the evidence available. Each naïve Bayes classifier assumes that the value of a specific variable is independent of any other variable/feature. For example, if a fruit needs to be classified based on color, shape, and taste. So yellow, oval, and sweet will be recognized as mango. Here each feature is independent of other features. Likewise, various embodiments herein can classify based on the selected game, player/team composition, historical data, etc.

Again, in the embodiment depicted in FIG. 14, an unsupervised learning system 1400B is shown. The unsupervised learning system 1400B can be configured with an unsupervised learning model 1440 that accepts input data 1430 and generates an output 1441. Unlike other model types, there are no critics or error signals to process. Unsupervised learning models 1440 can implement the learning process opposite to supervised learning, which means it enables the model to learn from an unlabeled training dataset. Based on the unlabeled dataset, the unsupervised learning model 1440 can predict the output. Using an unsupervised learning system 1400B, the unsupervised learning model 1440 can learn hidden patterns from the dataset by itself without any supervision. In various embodiments, unsupervised learning models 1440 are often utilized to perform tasks involving clustering, association rule learning, and/or dimensional reduction.

Clustering is an unsupervised learning technique that involves clustering or grouping the available data points into different clusters based on similarities and/or differences. The objects or data points with the most similarities remain in the same group, and they have no or very few similarities from other groups. Clustering algorithms can be used in a variety of different tasks such as, but not limited to image segmentation, statistical data analysis, market segmentation, and the like. Some commonly used clustering algorithms that can be selected include K-means Clustering, hierarchal Clustering, DBSCAN, etc.

Association rule learning is an unsupervised learning technique which finds unique relations among variables within a large data set. In many embodiments, a primary aim of this type of learning algorithm is to find the dependency of one data item on another data item and map those variables accordingly so that it can satisfy some desired outcome. For example, in certain embodiments, an association rule system may be utilized to generate a player or team with a maximized overall gameplay score. This algorithm can be applied in market basket analysis, web usage mining, continuous production, etc. However, those skilled in the art will recognize that other scenarios may be available based on the desired application. Some popular algorithms of association rule learning are Apriori Algorithm, Eclat, and FP-growth algorithm.

In additional embodiments, the number of features/variables present in a dataset can be understood as the dimensionality of the dataset, and the technique used to reduce the dimensionality is known as a dimensionality reduction technique. Although more data provides more accurate results, it can also affect the performance of the model/algorithm, such as yielding overfitting outcomes, etc. In such cases, dimensionality reduction techniques can be utilized. It is often desired that this process involves converting the higher dimensions dataset into lesser dimensions dataset while also ensuring that the ensuing results provide similar information. Different dimensionality reduction methods can be utilized, such as, but not limited to, PCA (Principal Component Analysis), Singular Value Decomposition (SVD), etc.

Finally, in the embodiment depicted in FIG. 14, a reinforcement learning system 1400C is shown. The reinforcement learning system 1400C can be configured with a reinforcement learning model 1460 that accepts input data 1450 and generates an output 1461. In reinforcement learning, the reinforcement learning model 1460 learns actions for a given set of states that lead to a goal state. In the embodiment depicted in FIG. 14, a critic 1480 can receive or otherwise notice an error 1470 within the reinforcement learning model 1460 actions, and adjust the outcome/output such that the “reward” or “punishment” is adjusted to better model the future behaviors or processing of the reinforcement learning model 1460.

It is a feedback-based learning model that can takes feedback signals after each state or action by interacting with the environment. This feedback works as a reward (positive for each good action and negative for each bad action), and the agent's goal is to maximize the positive rewards to improve their performance. The behavior of the model in reinforcement learning is similar to human learning, as humans learn things by experiences as feedback and interact with the environment. Popular methods of reinforcement learning including q-learning, state-action-reward-state-action (SARSA), and deep Q network.

Q-learning is one of the popular model-free algorithms of reinforcement learning, which is based on the Bellman equation. It often aims to learn the policy that can help the AI agent to take the best action for maximizing the reward under a specific circumstance. It can incorporate Q values for each state-action pair that indicate the reward to following a given state path, and it tries to maximize that Q-value.

SARSA is an on-policy algorithm based on the Markov decision process. In many embodiments, it can use the action performed by the current policy to learn the Q-value. The SARSA algorithm stands for State Action Reward State Action, which symbolizes the tuple (s, a, r, s′, a′). Finally, deep Q neural networking (or DQN) is Q-learning within a neural network. It can be deployed within a big state space environment where defining a Q-table would be a complex task. So, in these embodiments, rather than using a Q-table, the neural network instead utilizes Q-values for each action based on the state.

Although a specific embodiment for different methods of machine-based learning suitable for carrying out the various steps, processes, methods, and operations described herein is discussed with respect to FIG. 14, any of a variety of systems and/or processes may be utilized in accordance with embodiments of the disclosure. For example, those skilled in the art will recognize that methods of learning described herein are generalized and may incorporate other types developed as well as a combination of one or more methods based on the goals of the desired application. The elements depicted in FIG. 14 may also be interchangeable with other elements of FIGS. 1-13 and 15-16 as required to realize a particularly desired embodiment.

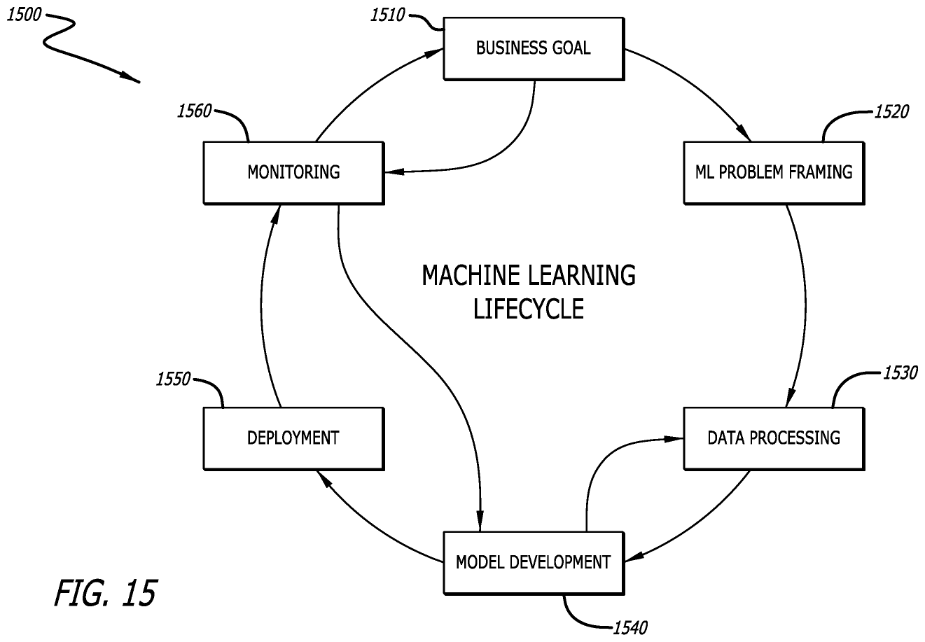

Referring to FIG. 15, a machine learning lifecycle 1500 in accordance with various embodiments of the disclosure is shown. During the development of machine learning systems, the embodiment depicted in FIG. 15 can provide a framework for how to structure the design and maintenance of these systems. This machine learning lifecycle 1500 outlines various stages involved in building, deploying, and improving ML models to solve real-world problems. By following this structured process, businesses and organizations can ensure that their machine learning projects align with strategic goals, use data effectively, and adapt to changing conditions over time. This machine learning lifecycle 1500 emphasizes that developing a machine learning model is not a one-time effort but an iterative process requiring ongoing monitoring and adjustment. The feedback loop inherent in the machine learning lifecycle 1500 allows for continual refinement and optimization of models to maintain their accuracy and relevance.

In many embodiments, a first stage of the machine learning lifecycle 1500 is identifying the business goal 1510, which sets the overall direction and purpose of the ML project. This can involve understanding the specific problems or opportunities within the business or project that machine learning can address. A clear business goal 1510 ensures that the project remains focused on delivering tangible value, whether it is improving player experiences, optimizing gametime operations, predicting gameplay run times, or automating onboarding systems. Without a well-defined goal, it can be challenging to align the subsequent stages of the ML lifecycle 1500, as the choice of model, data processing methods, and performance metrics can all depend on what the business aims to achieve.

Establishing a proper business goal 1510 can also involve engaging with key stakeholders and developers to gather requirements and set success criteria. It can provide a roadmap that outlines what success looks like and helps in framing the ML problem. For example, if the goal is to reduce processor overhead, the project might focus on building a predictive model that identifies potential bottlenecks, allowing the system to intervene proactively or generate notifications to facility operators. Clearly defined goals not only help guide the project but also provide benchmarks for evaluating the effectiveness of the deployed model once it enters production.

Once the business goal 1510 is established, various embodiments take a next step involving ML problem framing 1520, wherein the goal is translated into a specific machine learning task. This can involve selecting the appropriate type of ML problem, such as classification, regression, clustering, or recommendation, and defining the target variables or outputs. For example, if the goal is to identify processor bottlenecks, the problem can be framed as a binary classification task where the model predicts whether a certain number of interactive games will cause the flow of patrons within the facility to slow down. Proper problem framing can be important as it determines the particular data requirements, choice of model, and evaluation metrics.

During this stage, it is also prudent to consider the constraints and assumptions that may affect the model's development. This might include data availability, computational resources, ethical considerations, or regulatory compliance. Properly framing the problem ensures that the model development aligns with the business's needs and that the problem is broken down into manageable steps, ultimately increasing the project's chances of success.

Data processing 1530 is a step in many embodiments where raw data is collected, cleaned, and transformed into a format suitable for machine learning. This step can involve gathering data from various sources, removing errors or inconsistencies, handling missing values, and normalizing or scaling features to ensure that the model can learn effectively. Feature engineering is often a part of this stage, where new features are derived from the raw data to capture more relevant information and improve model performance.

The quality and preparation of the utilized data can significantly impact the model's accuracy and reliability. Inadequate or poorly processed data can lead to biased or inaccurate predictions, no matter how advanced the model is. Hence, data processing 1530 can require or at least benefit from careful planning and iterative refinement. Once the data is processed, it is typically split into training, validation, and test sets to develop and evaluate the model, ensuring that it generalizes well to new, unseen data.

Model development 1540 is a phase in a number of embodiments where machine learning algorithms are selected, trained, and refined to create a model that addresses the framed problem. This stage can involve choosing the appropriate algorithm (e.g., decision trees, neural networks, support vector machines), setting up the model's architecture, and defining hyperparameters that will guide the training process. The model is trained on the processed data to identify patterns and relationships that allow it to make predictions or decisions.

During model development 1540, the model can be evaluated using the validation dataset to fine-tune its parameters and improve performance. Techniques like cross-validation, regularization, and hyperparameter tuning can be used to prevent overfitting and ensure the model generalizes well. If proper steps are taken, the result is a model that, once it meets predefined performance metrics, is ready for deployment in a real-world environment. However, this process often involves several iterations to optimize the model for the specific business goal, indicated by the arrow back to data processing 1530.

In further embodiments, deployment 1550 is the stage where the developed model is integrated into the production environment to perform its intended tasks. This phase may involve setting up the necessary infrastructure, such as APIs or cloud-based services, to allow the model(s) to process live data and generate predictions. Deployment 1550 can transform the model from a research tool into a functional component of a business process or product, providing real-time insights, automations, or decisions.

Proper deployment 1550 can also include setting up mechanisms for logging, error handling, and user access. Since real-world environments are often dynamic and differ from training conditions, deployment may require continuous adaptation and updates to ensure the model(s) operates efficiently. This step can be important because a model's success is not only determined by its performance metrics but also by its ability to provide actionable results that align with the business goal 1510.

In more embodiments, monitoring 1560 is the ongoing process of tracking the model's performance and behavior after deployment. It involves collecting data on the model's predictions, accuracy, latency, and error rates to detect issues such as concept drift, where changes in the underlying data patterns can degrade the model's accuracy. By continuously monitoring 1560, teams can identify when the model's performance drops and requires retraining or adjustments to align with the evolving data.

Monitoring 1560 can also encompass aspects like user feedback, security, and compliance, ensuring that the model remains effective, reliable, and ethical in its application. It may serve as the feedback loop in the lifecycle, where insights gained from monitoring feed back into the earlier stages, particularly data processing 1530 and model development 1540, to refine the model(s) as needed. This iterative process allows the machine learning system to adapt and maintain its alignment with the original business goal 1510 over time.

Although a specific embodiment for a machine learning lifecycle 1500 suitable for carrying out the various steps, processes, methods, and operations described herein is discussed with respect to FIG. 15, any of a variety of systems and/or processes may be utilized in accordance with embodiments of the disclosure. For example, the particular route of development of the model(s) may not follow this cycle completely. As those skilled in the art will recognize, there are a variety of ways to develop AI products that include various iterative steps that aide in development and refinement of different model(s). The elements depicted in FIG. 15 may also be interchangeable with other elements of FIGS. 1-14 and 16 as required to realize a particularly desired embodiment.

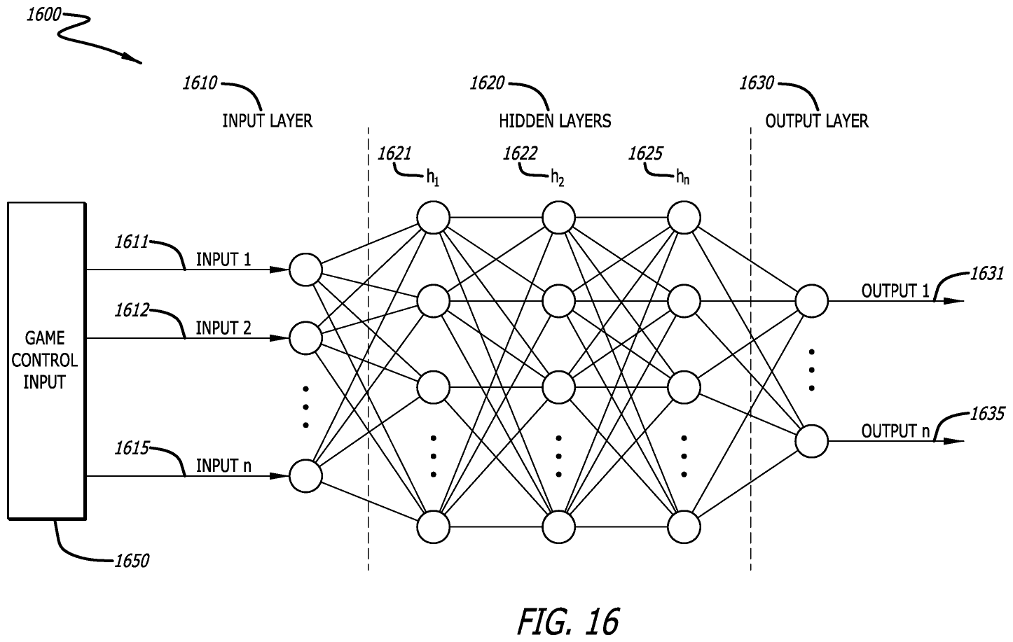

Referring to FIG. 16, an exemplary neural network 1600 in accordance with various embodiments of the disclosure is shown. The embodiment depicted specifically depicts a feedforward neural network with multiple layers. This type of network consists of an input layer 1610, one or more hidden layers 1620, and an output layer 1630. Each layer contains nodes (or neurons) that are interconnected, representing how data flows through the network. The input layer 1610 can receive raw data, which is then processed by the hidden layers 1620 through weighted connections and activation functions. These hidden layers 1620 can enable the network to learn complex patterns and relationships within the data.

The final output layer 1630 produces the network's predictions or classifications based on the processed input. The interconnected nature of the nodes allows the neural network 1600 to learn from data during training by adjusting the weights of connections to minimize prediction errors. This structure is the foundation of deep learning models, as adding more hidden layers 1620 can create a deep neural network, capable of tackling highly complex tasks such as image recognition, natural language processing, and pattern detection in large datasets.

A perceptron or a single artificial neuron is the building block of artificial neural networks (ANNs) and can perform forward propagation of information. For a set of inputs to the perceptron, weights (and biases to shift wights) can be assigned. These inputs and weights can be multiplied out correspondingly together to get a sum output. Those skilled in the art will recognize tools such as, but not limited to, PyTorch, Tensorflow, and MXNet as training packages for common neural network tasks. However, it is contemplated that other tools may be developed specifically for the neural network tasks related to the embodiments described herein.

In additional embodiments, the weight matrices of a neural network can be initialized randomly or obtained from a pre-trained model. These weight matrices can be multiplied with the input matrix (or output from a previous layer) and subjected to a nonlinear activation function to yield updated representations, which are often referred to as activations or feature maps. The loss function (also known as an objective function or empirical risk) can often be calculated by comparing the output of the neural network and the known target value data.

Feedforward networks, such as the neural network 1600 depicted in the embodiment of FIG. 16, are often configured as neural networks where information moves in one direction, from the input layer through the hidden layers to the output layer, without any cycles or loops. They are primarily used for tasks such as classification, regression, and simple pattern recognition, where each input is processed independently of others. In contrast, backpropagation is not a separate type of network but rather a training algorithm commonly used in both feedforward and other types of networks, like recurrent neural networks (RNNs).

Backpropagation involves adjusting the weights of the network in the reverse direction (from output to input) based on the error between the predicted output and the actual target during training. While feedforward describes the structure and data flow within the network, backpropagation is a technique used to optimize the model. Feedforward networks are ideal for straightforward tasks where input-output relationships are not sequential or time-dependent. However, for problems involving learning complex patterns over time, such as speech recognition or time-series analysis, networks that leverage backpropagation for training, like RNNs or deep feedforward networks with many hidden layers, become necessary to capture these intricate dependencies.

Typically, in these network arrangements, the weights are iteratively updated via various methods including, but not limited to, stochastic gradient descent algorithms in order to help minimize the loss function until the desired accuracy is achieved. Most modern deep learning frameworks can facilitate this by using reverse-mode automatic differentiation to obtain the partial derivatives of the loss function with respect to each network parameter through recursive application of the chain rule. Colloquially, this is also known as back-propagation. Common gradient descent algorithms can include, but are not limited to, Stochastic Gradient Descent (SGD), Adam, Adagrad etc. The learning rate is an important parameter in gradient descent. Except for SGD, all other methods use adaptive learning parameter tuning. Depending on the objective such as classification or regression, different loss functions such as Binary Cross Entropy (BCE), Negative Log Likelihood Loss (NLLL) or Mean Squared Error (MSE) can be used.

Neural network architecture is commonly used for a wide range of tasks in fields such as computer vision, natural language processing, financial forecasting, and materials science. For instance, it can be employed to recognize patterns in images, such as identifying objects or faces, or to classify text into categories, like spam detection in emails. It is also useful in regression problems, such as predicting stock prices or energy consumption, where input features can be processed to output continuous values. However, this is a general example of an artificial intelligence (AI) model, illustrating how a feedforward neural network works. Depending on the problem, other methods and models may be more appropriate. For example, convolutional neural networks (CNNs) are often used for image processing tasks, while recurrent neural networks (RNNs) are suitable for sequential data like time series data or text. Additionally, simpler models like linear regression, decision trees, or support vector machines (SVMs) may be sufficient if the problem is less complex, or the dataset is relatively small. The embodiment depicted in FIG. 16 is presented as an exemplary ML solution that may be deployed within one or more methods or systems described herein.

In many embodiments, the input layer 1610 is the first layer in a neural network 1600 and serves as the initial point where raw data is introduced into the model. Each node (or neuron) in this layer represents an individual feature or variable from the dataset, allowing the network to receive and process various types of data, such as pixel values in an image, numerical features in a spreadsheet, or words in a text document. For instance, in image recognition tasks, the input layer can consist of nodes that correspond to the pixel values of the image, providing the network with the visual information needed to identify objects or patterns. The number of nodes in the input layer directly depends on the number of features present in the dataset. If there are one-hundred features in the data, the input layer will typically have one-hundred nodes, each conveying one piece of the information to the subsequent layers. In more embodiments, the inputs of the neural network 1600 are generally scaled i.e., normalized to have a zero mean and/or unit standard deviation. Scaling can also be applied to the input of hidden layers (using batch or layer normalization) to improve the stability of neural network 1600.

Unlike the hidden layers 1620 and output layers 1630, the input layer 1610 typically does not perform any computations or transformations on the data. Its primary function is often to pass the input data to the next layer in the network, the first hidden layer 1621. However, it is often desired that the data fed into this layer is preprocessed appropriately, such as being normalized or standardized, to ensure that the neural network can learn efficiently. Proper preprocessing, like scaling numerical values or encoding categorical variables, can help the network process data uniformly, facilitating more stable and faster convergence during training.

The input layer's design depends on the nature of the problem. For example, in natural language processing, the input layer may represent words encoded as numerical vectors, while in time-series analysis, each node might represent a data point in a sequence. While the input layer 1610 itself does not modify the data, it sets the stage for the neural network to extract complex patterns and relationships through the deeper layers. This flexibility in handling various types of input make the neural network 1600 a powerful tool for a diverse set of applications.

With respect to the embodiments described herein, the input layer may be configured with a plurality of inputs providing game control data 1650, player attributes/parameters or other data sources. For example, a model can be configured with a first input 1611 configured as a first potential game selection to assign, a second input 1612 is configured with a second potential game selection for assignment, while additional inputs can be added related to the number of potential games within the system. The nth input 1615 can be configured in certain embodiments to include the current game selection such that a determination to keep the current game in place may be possible. However, as those skilled in the art will recognize, additional setups can be configured such that the inputs can be configured to also include different parameters of the facilities, the number of interactive game rooms or points of interest in the facility, the overall player historical scores of previous analyses, among other input types, etc.

In a number of embodiments, the neural network 1600 comprises a plurality of hidden layers 1620. The embodiment depicted in FIG. 16 comprises a first hidden layer 1621, a second hidden layer 1622, and an nth hidden layer 1625, which are denoted as h₁, h₂, and hₙ respectively. In many embodiments, the hidden layers 1620 are where the core of the model's learning and pattern recognition occurs. In each hidden layer, individual neurons receive inputs from the previous layer, apply a set of weights, add a bias, and pass the result through an activation function (e.g., ReLU, leaky ReLU, sigmoid, hyperbolic tangent (tanh), Swish, etc.). This process can introduce non-linearity, allowing the network to capture complex patterns in the data that simple linear models cannot. The intricate web of connections among neurons across layers helps the network transform and process input features into representations that become progressively more abstract and useful for making predictions.

The first hidden layer 1621 h₁ receives direct input from the input layer, transforming the raw data into an initial set of features. For example, in an image recognition task, this layer might begin identifying basic patterns, such as edges or simple textures. The output of the first hidden layer 1621 is then passed to a second hidden layer 1622 h₂, which builds upon the features identified by the first hidden layer 1621. This deeper layer might start recognizing more complex patterns, such as shapes or specific object components, by combining the lower-level features identified earlier. This can continue on until a last, nth hidden layer 1625 hₙ continues this abstraction process, allowing the network to recognize even higher-level, more detailed features, such as identifying an entire object within an image or understanding intricate relationships in the input data.

Each hidden layer adds a level of complexity and abstraction to the network's learning capabilities. The multi-layer structure can enable the network to move from recognizing simple patterns in the first hidden layer 1621 to highly complex, abstract concepts in the deeper layers. The number of hidden layers and neurons within them can vary depending on the problem's complexity. More hidden layers generally allow the network to model more intricate functions, making deep neural networks especially effective for tasks like image recognition, natural language processing, and complex predictive modeling. However, adding more layers also increases the computational demand and the risk of overfitting, highlighting the need to carefully design and tune these hidden layers for optimal performance.

In various embodiments, the output layer 1630 is often the final layer in a neural network and is responsible for producing the network's predictions or classifications based on the information processed through the previous hidden layers 1620. Each neuron in the output layer 1630 can represent a specific outcome or category that the model can predict. In the embodiment depicted in FIG. 16, the outputs are labeled as “output 1” to “output n,” indicating that the network can be designed to have a varying number of outputs depending on the nature of the problem being solved for. For example, in a binary classification task (e.g., selecting one game to play vs. selecting a second game to play), there would typically be a single output neuron that provides a probability score for one of the two classes/outcomes. In contrast, for multi-class classification (e.g., categorizing a best suited game between three or more potential games and/or team selections, etc.), the output layer would contain multiple neurons, each corresponding to a different class.

The number of neurons in the output layer 1630 can also designed specifically for other types of tasks, such as regression, where the model can predict continuous values. In such cases, the output layer 1630 might contain a single neuron representing a numerical prediction, such as the price of a house or the temperature forecast, etc. Alternatively, in complex applications like multi-label classification (where each input can belong to multiple classes simultaneously), the output layer 1630 could have multiple neurons, each representing a different class, with each neuron outputting a probability of the input belonging to that specific class.

The activation function used in the output layer can vary based on the desired output. For binary classification, a sigmoid function is commonly used to produce a probability between 0 and 1. For multi-class classifications, a softmax function can be applied to output a set of probabilities that sum to 1, indicating the most likely class. For regression problems, a linear activation function is often used to output a continuous range of values. The flexibility in designing the output layer allows the neural network 1600 to be applied to a wide variety of tasks, from simple binary decisions to complex multi-output predictions, making them a versatile tool in artificial intelligence and machine learning.

Although a specific embodiment for an exemplary neural network suitable for carrying out the various steps, processes, methods, and operations described herein is discussed with respect to FIG. 16, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 16, which is an illustrative example meant to make it easier to explain the basic concepts of neural networks and how they process information. The specific features and functions described herein are not intended to be limiting to this specific embodiment. Additionally, the elements depicted in FIG. 16 may also be interchangeable with other elements of FIGS. 1-15 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. An interactive game control system, comprising:
a processor;
a network internet controller; and
a memory, wherein the memory comprises a game control logic, wherein the game control logic directs the system to:
receive a plurality of player data;
generate a notification to players associated with a game start;
connect to at least one component within an interactive game room;
generate a game control interface;
monitor game states associated with the interactive game room; and
receive game control input.

2. The interactive game control system of claim 1, wherein the player data is received from a game onboarding process.

3. The interactive game control system of claim 1, wherein the notification can be generated as a display on a plurality of devices.

4. The interactive game control system of claim 3, wherein the plurality of devices includes a display in a preview room of an interactive game facility.

5. The interactive game control system of claim 3, wherein the plurality of displays includes a display at an entrance way of an interactive game room.

6. The interactive game control system of claim 1, wherein the notification can be generated as a push notification to a user.

7. The interactive game control system of claim 6, wherein the push notification is directed at a mobile computing device associated with the player.

8. The interactive game control system of claim 7, wherein access to the mobile computing device is gained from a game onboarding process.

9. The interactive game control system of claim 6, wherein the push notification is directed at a social media account associated with the player.

10. The interactive game control system of claim 9, wherein access to the social media account was gained during a game onboarding process.

11. The interactive game control system of claim 1, wherein the game control interface is generated via a graphical user interface.

12. The interactive game control system of claim 11, wherein the control interface is displayed on a display associated with a game technician.

13. The interactive game control system of claim 1, wherein monitored game states includes one of: team size, total score, room score, session identification number, team name, and players associated with the team.

14. The interactive game control system of claim 1, wherein connecting to at least one game component can be done via a network connection.

15. The interactive game control system of claim 14, wherein the at least one game component can be controlled by the game control logic.

16. The interactive game control system of claim 15, wherein control of the at least one game component can allow for suspension of the game.

17. The interactive game control system of claim 15, wherein control of the at least one game component can allow for termination of the game.

18. The interactive game control system of claim 15, wherein control of the at least one game component can allow for starting a game.

19. The interactive game control system of claim 15, wherein control of the at least one game component can allow for a selection of an interactive game from a list of compatible interactive games.

20. The interactive game control system of claim 12, wherein the game technician can manually adjust an allocation of players amongst two or more teams available for gameplay.
